(19) United States
(12) Patent Application Publication
(10) Pub. No.: US 2007/0281143 A1
(43) Pub. Date: Dec. 6, 2007

(54) Diffusely-reflecting element and method of making

(76) Inventors: Peter T. Aylward, Hilton, NY (US); Thomas M. Laney, Spencerport, NY (US); Xiang-Dong Mi, Rochester, NY (US); Robert P. Bourdelais, Pittsford, NY (US)

Correspondence Address: Andrew J. Anderson;Patent Legal Staff, Eastman Kodak Company, 343 State Street, Rochester, NY, 14650-2201, US

(21) Appl. No.: 11/643,429

(22) Filed: Dec. 21, 2006

Related U.S. Application Data
(60) Provisional application No. 60/810,965, filed on Jun. 5, 2006.

(51) Int. Cl. B32B 7/02

(52) U.S. Cl. 428/212

(57) ABSTRACT

A process for making a diffusely reflecting polarizer comprises the steps of arranging polymeric fibers containing certain fibrils and forming a solid film. A diffusely-reflective polarizer employs the film to effect polarization.

### CROSS REFERENCE TO RELATED APPLICATION

This application claims priority of Provisional Application 60/810,965 filed Jun. 5, 2006, the contents of which are incorporated herein by reference.

### FIELD OF THE INVENTION

This invention relates to a diffusely reflecting optical element comprising a film containing a layer including continuous phase and discontinuous phase materials, wherein the discontinuous phase materials are fibrils and include a birefringent material having a different refractive index in the orthogonal X and Y directions in a plane perpendicular to the direction of light travel. Additional processes for making a diffusely-reflecting polarizer are described.

### BACKGROUND OF THE INVENTION

Reflective polarizing films transmit light of one polarization and reflect light of the orthogonal polarization. They are useful in an LCD to enhance light efficiency. A variety of films have been disclosed to achieve the function of the reflective polarizing films, among which diffusely reflecting polarizers are more attractive because they may not need a diffuser in a LCD, thus reducing the complexity of the LCD.

U.S. Pat. Nos. 5,783,120 and 5,825,543 teach a diffusely reflecting polarizing film including a first birefringent phase and a second phase, wherein the first phase having a birefringence of at least about 0.05. The film is oriented, typically by stretching, in one or more directions. The size and shape of the disperse phase particles, the volume fraction of the disperse phase, the film thickness, and the amount of orientation are chosen to attain a desired degree of diffuse reflection and total transmission of electromagnetic radiation of a desired wavelength in the resulting film. Among 124 samples shown in Table 1 through Table 4, most of which include polyethylene naphthalate (PEN) as a major and birefringent phase (more than 50% of the blend), with PMMA (Example 1) or sPS (other examples) as a minor phase (less than 50% of the blend), except example numbers 6, 8, 10, 15, 16, 42-49, wherein PEN is the minor phase.

U.S. Pat. Nos. 5,783,120 and 5,825,543 also summarize a number of alternative films, which are described below.

Films filled with inorganic inclusions with different characteristics can provide optical transmission and reflective properties. However, optical films made from polymers filled with inorganic inclusions suffer from a variety of infirmities. Typically, adhesion between the inorganic particles and the polymer matrix is poor. Consequently, the optical properties of the film decline when stress or strain is applied across the matrix, both because the bond between the matrix and the inclusions is compromised, and because the rigid inorganic inclusions may be fractured. Furthermore, alignment of inorganic inclusions requires process steps and considerations that complicate manufacturing.

Other films, such as that disclosed in U.S. Pat. No. 4,688,900 (Doane et. al.), consists of a clear light-transmitting continuous polymer matrix, with droplets of light modulating liquid crystals dispersed within. Stretching of the material reportedly results in a distortion of the liquid crystal droplet from a spherical to an ellipsoidal shape, with the long axis of the ellipsoid parallel to the direction of stretch. U.S. Pat. No. 5,301,041 (Konuma et al.) make a similar disclosure, but achieve the distortion of the liquid crystal droplet through the application of pressure. A. Aphonin, “Optical Properties of Stretched Polymer Dispersed Liquid Crystal Films: Angle-Dependent Polarized Light Scattering, Liquid Crystals, Vol. 19, No. 4,469-480 (1995), discusses the optical properties of stretched films consisting of liquid crystal droplets disposed within a polymer matrix. He reports that the elongation of the droplets into an ellipsoidal shape, with their long axes parallel to the stretch direction, imparts an oriented birefringence (refractive index difference among the dimensional axes of the droplet) to the droplets, resulting in a relative refractive index mismatch between the dispersed and continuous phases along certain film axes, and a relative index match along the other film axes. Such liquid crystal droplets are not small as compared to visible wavelengths in the film, and thus the optical properties of such films have a substantial diffuse component to their reflective and transmissive properties. Aphonin suggests the use of these materials as a polarizing diffuser for backlit twisted nematic LCDs. However, optical films employing liquid crystals as the disperse phase are substantially limited in the degree of refractive index mismatch between the matrix phase and the dispersed phase. Furthermore, the birefringence of the liquid crystal component of such films is typically sensitive to temperature.

U.S. Pat. No. 5,268,225 (Isayev) discloses a composite laminate made from thermotropic liquid crystal polymer blends. The blend consists of two liquid crystal polymers which are immiscible with each other. The blends may be cast into a film consisting of a dispersed inclusion phase and a continuous phase. When the film is stretched, the dispersed phase forms a series of fibers whose axes are aligned in the direction of stretch. While the film is described as having improved mechanical properties, no mention is made of the optical properties of the film. However, due to their liquid crystal nature, films of this type would suffer from the infirmities of other liquid crystal materials discussed above.

Still other films have been made to exhibit desirable optical properties through the application of electric or magnetic fields. For example, U.S. Pat. No. 5,008,807 (Waters et al.) describes a liquid crystal device which consists of a layer of fibers permeated with liquid crystal material and disposed between two electrodes. A voltage across the electrodes produces an electric field, which changes the birefringent properties of the liquid crystal material, resulting in various degrees of mismatch between the refractive indices of the fibers and the liquid crystal. However, the requirement of an electric or magnetic field is inconvenient and undesirable in many applications, particularly those where existing fields might produce interference.

Other optical films have been made by incorporating a dispersion of inclusions of a first polymer into a second polymer, and then stretching the resulting composite in one or two directions. U.S. Pat. No. 4,871,784 (Otonari et al.) is exemplative of this technology. The polymers are selected such that there is low adhesion between the dispersed phase and the surrounding matrix polymer, so that an elliptical void is formed around each inclusion when the film is stretched. Such voids have dimensions of the order of visible wavelengths. The refractive index mismatch between the void and the polymer in these “microvoided” films is typically quite large (about 0.5), causing substantial diffuse reflection. However, the optical properties of microvoided materials are difficult to control because of variations of the geometry of the interfaces, and it is not possible to produce a film axis for which refractive indices are relatively matched, as would be useful for polarization-sensitive optical properties. Furthermore, the voids in such material can be easily collapsed through exposure to heat and pressure.

Optical films have also been made wherein a dispersed phase is deterministically arranged in an ordered pattern within a continuous matrix. U.S. Pat. No. 5,217,794 (Schrenk) is exemplative of this technology. There, a lamellar polymeric film is disclosed which is made of polymeric inclusions which are large compared with wavelength on two axes, disposed within a continuous matrix of another polymeric material. The refractive index of the dispersed phase differs significantly from that of the continuous phase along one or more of the laminate's axes, and is relatively well matched along another. Because of the ordering of the dispersed phase, films of this type exhibit strong iridescence (i.e., interference-based angle dependent coloring) for instances in which they are substantially reflective. As a result, such films have seen limited use for optical applications where optical diffusion is desirable.

The performance potential and flexibility of polarized displays, especially those utilizing the electro-optic properties of liquid crystalline materials, has led to a dramatic growth in the use of these displays for a wide variety of applications. Liquid crystal displays (LCDs) offer the full range from extremely low cost and low power performance (e.g. wristwatch displays) to very high performance and high brightness (e.g. AMLCDs for avionics applications, computer monitors and HDTV LCD's). Much of this flexibility comes from the light valve nature of these devices, in that the imaging mechanism is decoupled from the light generation mechanism. While this is a tremendous advantage, it is often necessary to trade performance in certain categories such as luminance capability or light source power consumption in order to maximize image quality or affordability. This reduced optical efficiency can also lead to performance restrictions under high illumination due to heating or fading of the light-absorbing mechanisms commonly used in the displays.

In portable display applications such as backlit laptop computer monitors or other instrument displays, battery life is greatly influenced by the power requirements of the display backlight. Thus, functionality must be compromised to minimize size, weight and cost. Avionics displays and other high performance systems demand high luminance but yet place restrictions on power consumption due to thermal and reliability constraints. Projection displays are subject to extremely high illumination levels, and both heating and reliability must be managed. Head mounted displays utilizing polarized light valves are particularly sensitive to power requirements, as the temperature of the display and backlight must be maintained at acceptable levels.

Previous disclosure displays suffer from low efficiency, poor luminance uniformity, insufficient luminance and excessive power consumption that generates unacceptably high levels of heat in and around the display. Previous disclosure displays also exhibit a non-optimal environmental range due to dissipation of energy in temperature sensitive components. Backlight assemblies are often excessively large in order to improve the uniformity and efficiency of the system.

Several areas for efficiency improvement are readily identified. Considerable effort has gone into improving the efficiency of the light source (e.g. fluorescent lamps) and optimizing the reflectivity and light distribution of backlight cavities to provide a spatially uniform, high luminance light source behind the display. Pixel aperture ratios are made as high as the particular LCD approach and fabrication method will economically allow. Where color filters are used, these materials have been optimized to provide a compromise between efficiency and color gamut Reflective color filters have been proposed for returning unused spectral components to a backlight cavity.

When allowed by the display requirements, some improvement can also be obtained by constricting the range of illumination angles for the displays via directional techniques.

Even with this previous disclosure optimization, lamp power levels must be undesirably high to achieve the desired luminance. When fluorescent lamps are operated at sufficiently high power levels to provide a high degree of brightness for a cockpit environment, for example, the excess heat generated may damage the display. To avoid such damage, this excess heat must be dissipated. Typically, heat dissipation is accomplished by directing an air stream to impinge upon the components in the display. Unfortunately, the cockpit environment contains dirt and other impurities that are also carried into the display with the impinging air, if such forced air is even available. Presently available LCD displays cannot tolerate the influx of dirt and are soon too dim and dirty to operate effectively.

Another drawback of increasing the power to a fluorescent lamp is that the longevity of the lamp decreases dramatically as ever higher levels of surface luminance are demanded. The result is that aging is accelerated which may cause abrupt failure in short periods of time when operating limitations are exceeded.

Considerable emphasis has also been placed on optimizing the polarizers for these displays. By improving the pass-axis transmittance (approaching the theoretical limit of 50%), the power requirements have been reduced, but the majority of the available light is still absorbed, constraining the efficiency and leading to polarizer reliability issues in high throughput systems as well as potential image quality concerns.

A number of polarization schemes have been proposed for recapturing a portion of the otherwise lost light and reducing heating in projection display systems. These include the use of Brewster angle reflections, thin film polarizers, birefringent crystal polarizers and cholesteric circular polarizers. While somewhat effective, these previous disclosure approaches are very constrained in terms of illumination or viewing angle, with several having significant wavelength dependence as well. Many of these add considerable complexity, size or cost to the projection system, and are impractical on direct view displays. None of these previous disclosure solutions are readily applicable to high performance direct view systems requiring wide viewing angle performance.

Also taught in the previous disclosure (U.S. Pat. No. 4,688,897) is the replacement of the rear pixel electrode in an LCD with a wire grid polarizer for improving the effective resolution of twisted nematic reflective displays, although this reference falls short of applying the reflective polarizing element for polarization conversion and recapture. The advantages that can be gained by the approach, as embodied in the previous disclosure, are rather limited. It allows, in principle, the mirror in a reflective LCD to be placed between the LC material and the substrate, thus allowing the TN mode to be used in reflective mode with a minimum of parallax problems. While this approach has been proposed as a transflective configuration as well, using the wire grid polarizer instead of the partially-silvered mirror or comparable element, the previous disclosure does not provide means for maintaining high contrast over normal lighting configurations for transflective displays. This is because the display contrast in the backlit mode is in the opposite sense of that for ambient lighting. As a result, there will be a sizable range of ambient lighting conditions in which the two sources of light will cancel each other and the display will be unreadable. A further disadvantage of the previous disclosure is that achieving a diffusely reflective polarizer in this manner is not at all straightforward, and hence the reflective mode is most applicable to specular, projection type systems.

Taught in the previous disclosure (U.S. Pat. No. 2,604,817) and later in the previous disclosure(U.S. Pat. No. 5,999,239) is one such means to produce a diffusely reflective polarizer utilizing polymeric fibers dispersed in a continuous polymer matrix. Typical monofilament birefringent fibers(ex, polyester) were demonstrated to create such a diffuse reflective polarizer in (U.S. Pat. No. 2,604,817). These fibers are embedded into an isotropic polymer matrix. The manufacturability and optical performance of such a reflective polarizer utilizing even the smallest typical monolithic birefringent fibers, however, is not sufficient enough to enable such a diffuse reflective polarizer to be cost effective.

In U.S. Pat. Nos. 5,296,965; 5,444,570 and 5,296,965 polarization screens and a means of making are discussed. U.S Pat. Nos. 5,444,570 and 5,251,065 are an absorptive polarizer with dichroic dyes and in some cases black threads adjacent to other threads in an attempt to improve the viewing contrast. Other types of screens also contain metallic layer to enhance reflection properties. The screen do not reflective polarizer light, they absorb it and the screens are direction viewing for a projection type system. A fabric is discussed as a way to make the screens. U.S. Pat. No. 5,296,965 describes a reflection type screen that provide an improved screen of reflection type less susceptible to reduction in image quality which would otherwise occur under the influence of an increased local reflection of the rays of light projected onto the screen,. Again this patent describes a screen that is used to project an image on using polarized light.

There still remains a need for an optical film comprising an optical element comprising a film containing a layer including continuous phase and discontinuous phase materials, wherein the discontinuous phase materials include a birefringent material having a different refractive index in the orthogonal X and Y directions in a plane perpendicular to the direction of light travel and a process for making same.

### SUMMARY OF THE INVENTION

The invention provides an optical element and a process for making such an optical element. The element is a diffusive reflective polarizer with a mismatched discontinuous phase that provides improved Figure of Merit.

### BRIEF DESCRIPTION OF THE DRAWINGS

FIG. 1A is a end cross-sectional view of an island in the sea fiber

FIG. 1B is a 3D projected view of an island in the sea fiber

FIG. 2 is a 3d view showing the ordinary and extra-ordinary optical axis of an island in the sea fiber.

FIG. 3 is a 3D view of a solid film 130 formed from ribbon shaped island in the sea fibers 131 with flat plate-like fibrils 133 that have been fused together by melting the sea polymer 135.

FIG. 4A is an end cross-sectional view of an island in the sea fiber with a circular outer fiber and elliptical fibrils.

FIG. 4B is an end cross-sectional view of an island in the sea fiber with a circular outer fiber and circular fibrils.

FIG. 4C is an end cross-sectional view of an island in the sea fiber with a elliptical outer fiber and flat ribbon-like fibrils.

FIG. 4D is an end cross-sectional view of an island in the sea fiber with a elliptical outer fiber and a mix of circular and elliptical fibrils.

FIG. 4E is an end cross-sectional view of an island in the sea fiber with a ribbon(rectilinera) outer fiber and elliptical fibrils.

FIG. 4F is an end cross-sectional view of an island in the sea fiber with a ribbon(rectilinera) outer fiber and fibril.

FIG. 4G is an end cross-sectional view of an island in the sea fiber with a circular outer fiber and triangular fibrils.

FIG. 4H is an end cross-sectional view of an island in the sea fiber with a circular outer fiber and star shaped fibril.

FIG. 4I is a 3D view of an island in the sea fiber with a ribbon(rectilinera) outer fiber and flat plate-like fibrils.

FIG. 4J is a 3D view of an island in the sea fiber with a ribbon(rectilinera) outer fiber and circular fibrils.

FIG. 4K is a cross-sectional end view of a ribbon(rectilinera) outer fiber and elliptical fibrils with lens on the surface.

FIG. 4L is a cross-sectional end view of a ribbon(rectilinera) outer fiber and elliptical fibrils with lens on the surface that also contain fibril in the lens.

FIG. 5 is a top view of a woven fabric with island is the sea fiber in the vertical direction and isotropic fibers in the horizontal direction.

FIG. 6 is an end view of an optical film contain island in the sea fibers encased in a polymer matrix.

FIG. 7A is an end view of several island in the sea fiber that are touching each other.

FIG. 7B is an end view of several island in the sea fibers that have been fused together and then embedded in a polymer matrix.

FIG. 8 is a top view of a woven fabric with island in the sea fibers in the vertical direction and isotropic fiber that have been processed to fill the interstices.

FIG. 9 is a bundle of island in the sea fibers with internal fibrils embedded in a sizing material.

FIG. 10A is a top view of a woven diffuse reflecting polarizing sheet in which the polymeric fiber with internal fibrils are parallel to each other in the width direction throughout their length direction.

FIG. 10B is an end view of the width dimension of a woven diffuse reflecting polarizing sheet that has been melt fused together. The polymeric fiber has the internal fibrils parallel to each other. The polymeric fibers are embedded in sea polymer.

FIG. 10C is a side view of the length dimension of a diffuse reflecting polarizing sheet in which the fibrils are essential parallel to each other with the sea polymer but change their relative position in their height as a result of the interlacing with isotropic fibers.

FIG. 11 is a 3D view of bi-component fiber with internal fibril with a sea polymer between the fibrils. The fibril was made with an immiscible blend of polymer to form a non-continuous segment surrounded by a matrix polymer.

### DETAILED DESCRIPTION OF THE INVENTION

The present invention substantially eliminates the various problems inherent in the previous disclosure screens and provides an improved polarizing optical film by providing a film the is formed by bi or multi-component fibers that are wound in a manner to align the fibers and then fuse or otherwise join them and then fill any interstices between the joined fiber, or woven polarizing fabric that comprises warp or weft fibers, one of which is a polarizing island in the sea fiber and the other is a non-polarizing (isotropic) fiber in the opposite direction. An island in the sea fiber is a polymeric fiber that comprise discontinuous phase polymeric fibrils substantially parallel to each other and dispersed in a polymeric continuous phase wherein there is a difference in the birefringence between the continuous and discontinuous polymeric phases. The fibrils are substantially aligned in a parallel array and then the array is formed into a continuous solid film wherein the interstices between fibers are filled with polymeric material. Prior to forming the aligned fibers into a continuous solid film, the polymeric fibers may be either polarizing or non-polarizing. The process of forming the continuous film further enhances the polarization effect by making them more transparent to one phase of light and more reflective to the other phase of light. In general the fibril within a fiber are parallel to each other within 5 degrees of each other within at least one special dimension (X, Y and or Z). Furthermore it is desirable to have the fibers substantially all fibers and their fibril parallel to each other in order to provide the maximum polarization efficiency of the optical film. The fibers useful in this invention are at least bicomponent fibers wherein there are many fibrils internal to a filament with a surrounding sea polymer. There should be a difference in the relative birefringence between the sea polymer and fibril polymer. This is important after any processing of the fibers, particularly if the fibers are formed into a film.

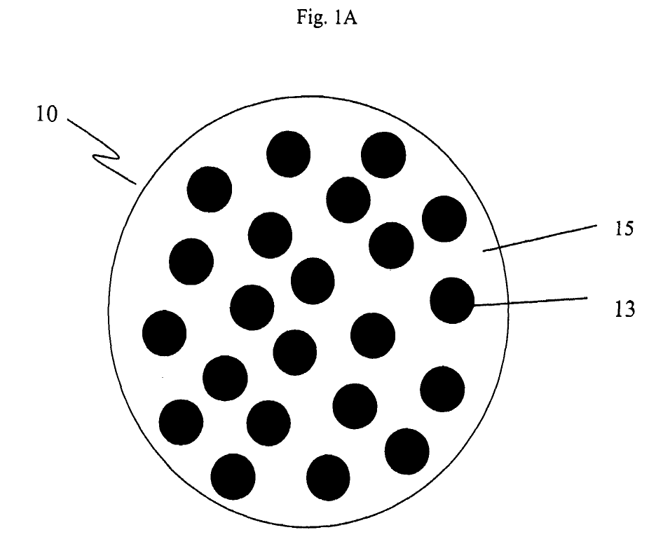

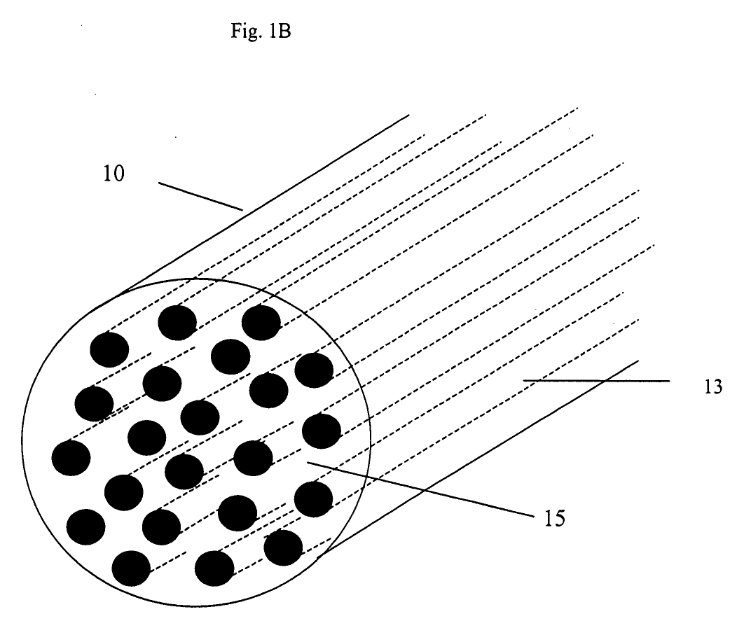

FIG. 1A is an end view of an island in the sea fiber 10 with a continuous phase 15 and with internal fibrils 13 (discontinuous phase). These fibers and the melt process for making the island in the sea fiber provide a unique means fibers with multi-components. The internal fibrils are directly extruded and with the proper selection of materials, the fibers may be highly polarizing. The orifice/flow plates used to make fibers of this type as well as other fibril shapes can easily be made with a photolithography and etching process. In such a process any shape that can de digitally created can be etched into a plate that provides the necessary flow path that allows the shape to be extruded and surrounded by another polymer. Such a process is very flexible and is easier than having to mechanically machine the complex array of holes, flow channel and means of dividing the flow and recombining the flows. With such a process nanometer scale fibrils of varying shapes can be made and used in an extrusion process to make fibers. Such fibers can be made to polarize light. By aligning and forming the individual filaments into bundles of yarn, a film or fabric material can be formed to create a polarizing sheet.

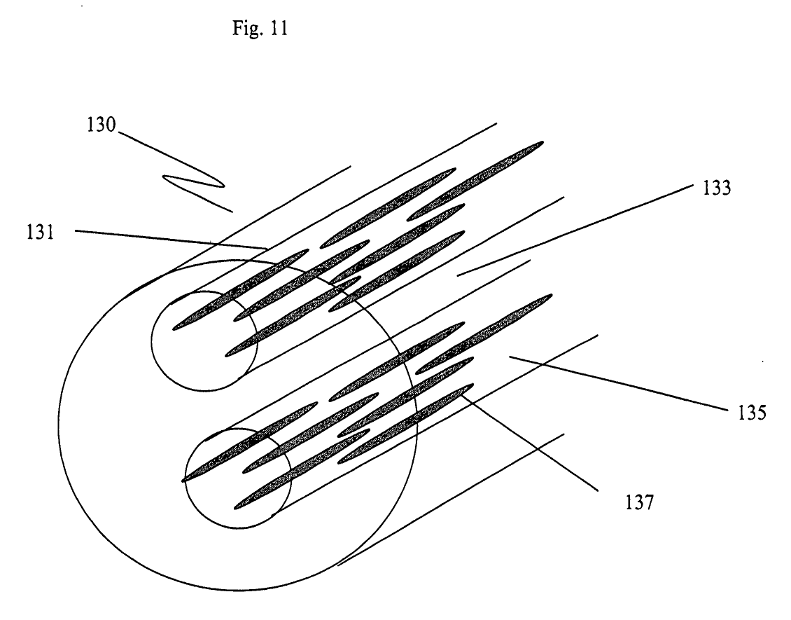

FIG. 1B is a 3D view of an island in the sea fiber 10 with the projection of the fibril 13 is the length direction with a continuous phase polymer (sea) 15 between the fibers. In general the fibrils are continuous in their length direction. One exception to this is shown in FIG. 11.

FIG. 2 is a 3D view of the island in the sea fiber 10 with fibril 13 and sea polymer 15. The sea polymer comprises 3 dimension of birefringence. The fiber and the internal fibril are stretched in the length direction and therefore there is an ordinary refractive index for the sea polymer in the x and y plane and an extraordinary index in the length direction as shown by symbol 17 and the island polymer also has an ordinary index and an extraordinary index that may be different than the sea polymer index.

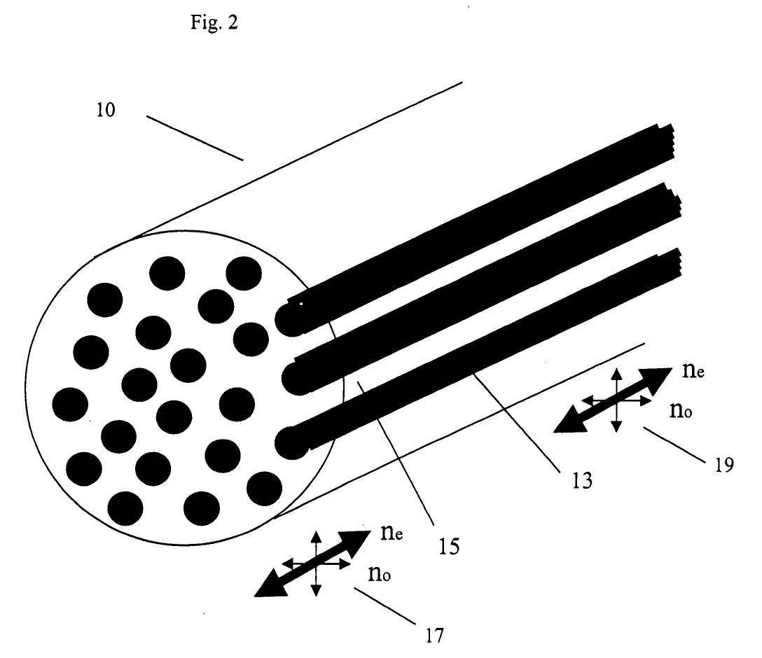

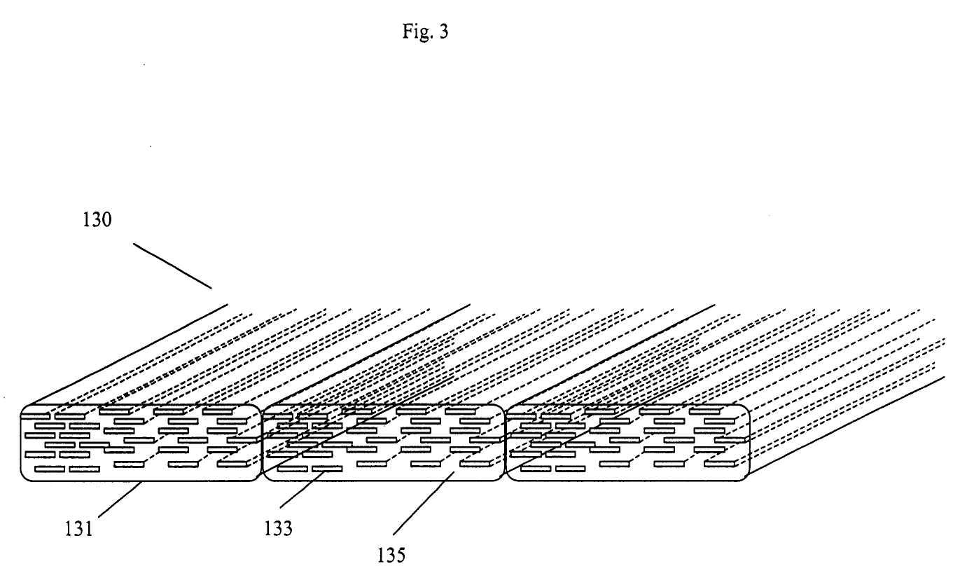

FIG. 3 is a 3D view of a solid film 130 formed from ribbon shaped island in the sea fibers 131 with flat plate-like fibrils 133 that have been fused together by melting the sea polymer 135. It should be noted that other means of may also be used to fill the interstices between the fibers. Such means may include the addition of a UV monomer or chemically cross-linked material. Solution polymer may also be used to fill and join the fibers.

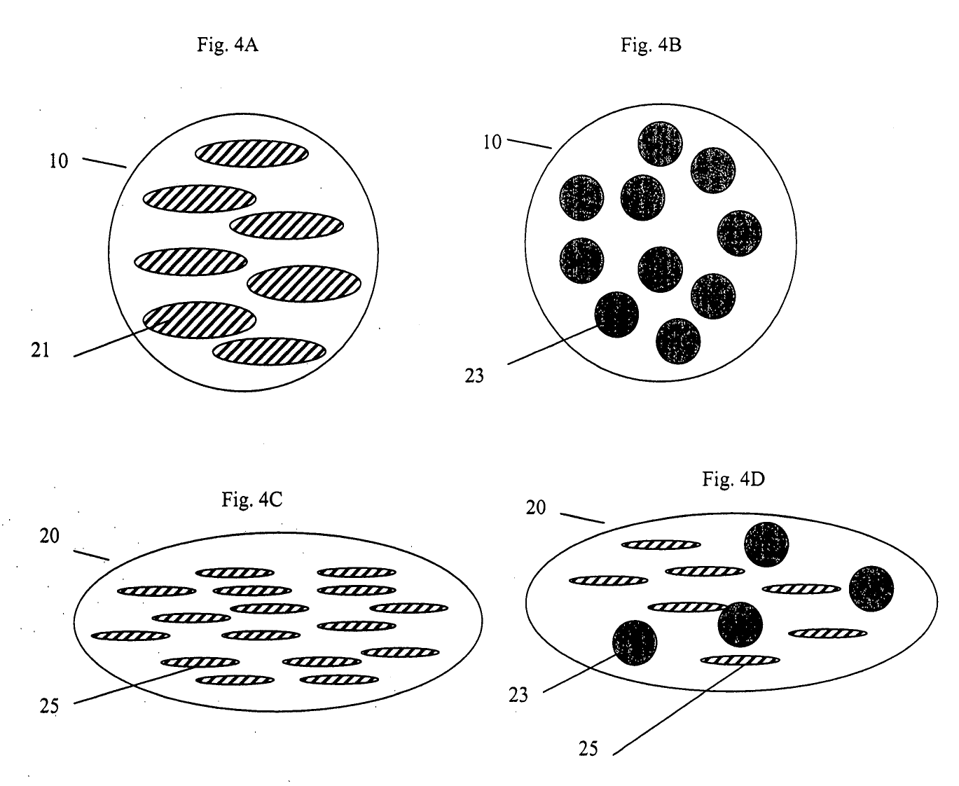

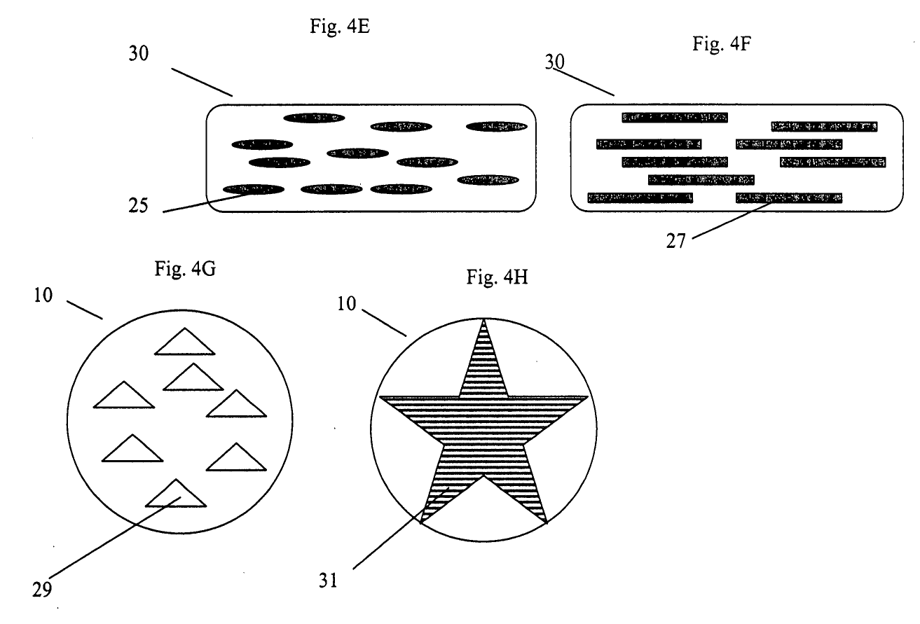

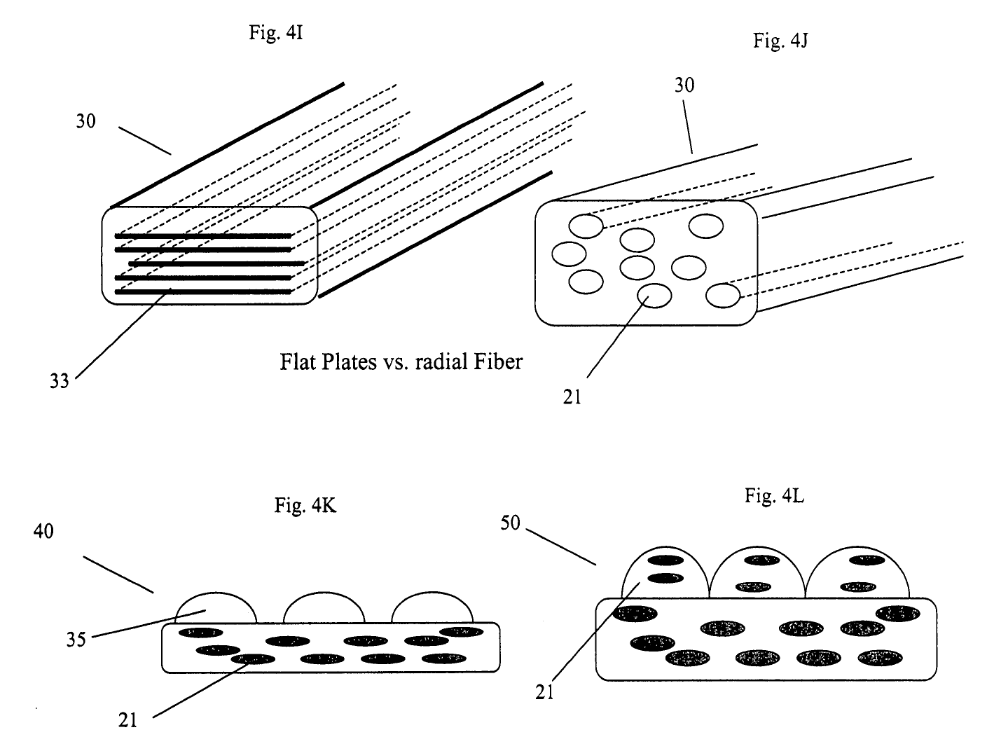

A variety of shapes may be manufactured. FIG. 4A-4l are a few examples of the types of fibrils that could be made with a fiber process that uses a photolithography and etching process to made the orifice/flow plates. These Figures provides some examples but any shape that can to digitally created can ultimately be made into plates that form unique fibrils. Such fibrils shapes are designed to improve the overall efficiency of the resulting optical element. They may be designed to reflect light or one phase of light in a diffuse or spectral manner or they may be designed to provide forward scattering of light or one polarization of light. They may also be used to help collimate light or provide light diffusion. It should be noted that in this figure as well as other shown in this disclosure, the size, shape and number that are graphically depicts serves only as a means to visualize the general example. In reality, the size is typically in the sub-micron to few microns range and the shape may vary due to viscoelastic properties of the polymers during processing.

FIG. 4A is an island in the sea fiber 10 with elliptical fibrils 21. Embodiments with elliptical, oval, elongated ovals or oval-like are useful because if they are stretched the fibril is elongated and present a larger surface area for light reflection.

FIG. 4B is an island in the sea fiber 10 with radical fibrils 23. Embodiments useful in this invention with circular shapes are useful because may interfaces can be packed into a small space. To maximize the packing density of the fibrils varying shapes and sizes are useful, while hexagonal shapes provide even higher packing densities. It should be noted that to maximize the performance of a reflective polarizer there should also be appropriate spacing between the fibrils. Typically a similar size (thickness) between fibrils is useful. By providing a more random spacing, a broader band wavelength of light can be polarized.

FIG. 4C is an elliptical island in the sea fiber 20 with flat fibrils 25. In another embodiment of this invention the fiber shape may be different than the fibril shape. This provides improved latitude in the processing of the fiber as in winding and weaving. Good positional proximity between the fiber helps to provide a more uniform polarization effect, while the flat fibrils provide surfaces that optimal light transmission and reflection.

FIG. 4D is an elliptical island in the sea fiber 20 with mixed shapes and size fibrils 23 and 25. By mixing shapes and sizes of the fibrils, useful embodiments will have a more uniform transmission and reflection over a broader range of the electromagnetic spectrum.

FIG. 4E is a ribbon shaped island in the sea fiber 30 with flat shaped fibrils 25. Ribbon shapes are useful in that they are wider than flatter and when winding and or weaving fibers, fewer fibers are needed to cover the surface area required.

FIG. 4F is a ribbon shaped island in the sea fiber 20 with random plate-like fibrils 27. Plate-like fibrils are useful in that they provide a large and near flat surface larger that helps to enhance the maximum reflection or transmission of light. It should also be noted that with plate-like fibrils, the surrounding sea polymer while continuous is also near plate-like between the fibrils. Again helping to assure optimal light properties.

FIG. 4G is an island in the sea fiber 10 with triangular shaped fibrils 29. Triangular shapes fibrils provide excellent polarization properties.

FIG. 4H is an island in the sea fiber 10 with a star shaped fibril 31. Star shapes can provide unique light dispersion because of their more faceted-like surfaces

FIG. 4I is a ribbon like island in the sea fiber 30 with stacked plate-like fibrils 33. Stacked plate-like fibrils are typical more uniform in their surfaces and in general more parallel to the surface of the resulting film that is formed after the fibers are processed into a film or fabric-like element.

FIG. 4J is a ribbon like island in the sea fiber 30 with elliptical shaped fibrils 21. In this embodiment the ribbon-like fiber provide good packing of wider when they are wound or woven and may also have less drastic contour changes between fibers and therefore require less filling. While the elliptical fibrils provide very good surface qualities with they subtle thickness variations. Such changes are useful in providing broader band light properties.

FIG. 4K is a ribbon like island in the sea fiber 40 with integral lens shapes 35 and fibrils 21. Round fibers in general and not specific to this embodiment are somewhat easier to wind and weave because when they twist they do not change relative height from fiber to fiber and therefore the internal fibrils are not twisted and the resulting film is more uniform and less rough. Lens shaped fibrils may also provide some light shaping due to the lens effect. Maximizing the differences in refractive index between the fibril and the surrounding sea polymer will help to maximize this effect.

FIG. 4L is a ribbon like island in the sea fiber 40 with integral lens shapes 35 and fibril in lens shapes. Ribbon-like and square fibers pack well when wound and generally can provide surfaces that have less contour spacing between the fibers and therefore do not requires as much filling of the interstices.

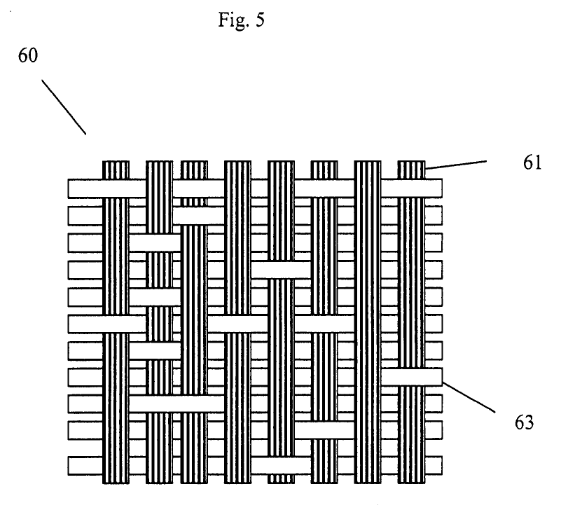

FIG. 5 is a plane view of a woven polarizer 60 with polarizing island in the sea fibers 61 in the vertical direction and isotropic fiber 63 is the horizontal direction. The weaving process is described in other section of this description but in general the weaving process provides a means of alignment the polarizing fiber and their fibrils to maximize the light efficiency of the optical element. When used as a polarizer providing a process that enhances the degree of parallelism between the fibers is useful in providing the maximum transmission of one polarization of light and the reflection of the other polarization phase.

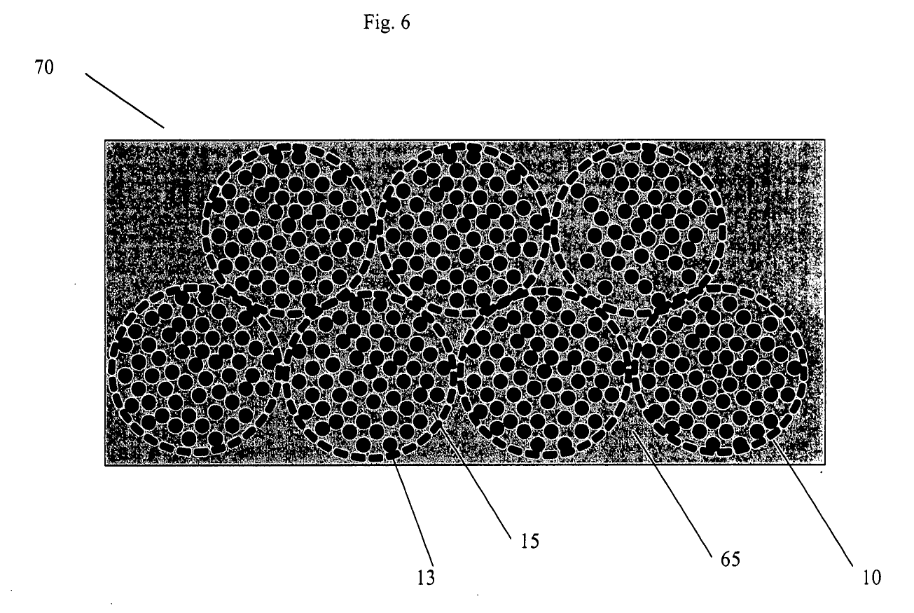

FIG. 6 is an end view of a fibrous polarizer 70 embedded in a polymer 65. Island in the sea fibers 10 have fibrils 13 and surrounding sea polymer 15. The islands in the sea fibers are stacked and embedded in a polymer matrix 65 that is substantially index matched to the sea polymer 15. The stacking or forming of multiple layers of island in the sea fibers is useful because it provides a means of increasing the number of optical interfaces in the thickness direction. Various embodiments using this approach will provide more uniform optical properties by nesting a polarizing fiber between at least two other fibers. As light travels in the thickness plane of the embodiments made with fibers that have a changing thickness profile, nesting fibers in the valley between two other fibers helps to maximize the number of optical interfaces formed by the fibrils and the sea polymer. While this figure shows only two layers, many more stacks or layers may be useful as well as fibers with different sizes will help to assure a more uniform film profile.

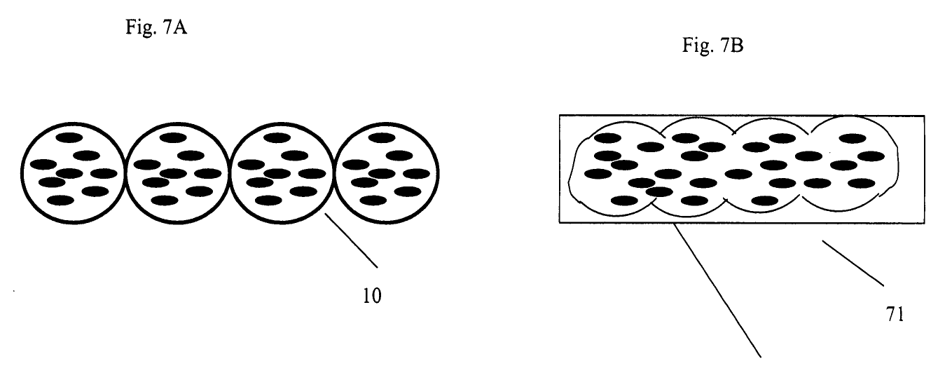

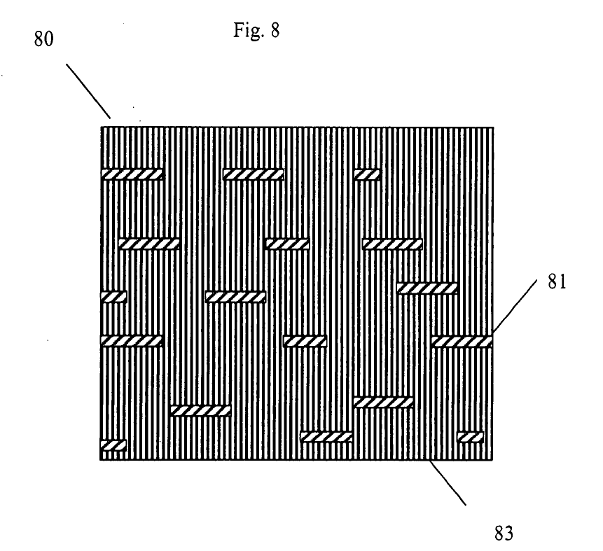

FIG. 7A is an end view of several island in the sea fiber 10 that have been grouped together so that their outer surfaces are touching each other. When winding fibers together, some care is necessary to assure that when the fibers are processed to form a film such as melting, there is an appropriate distribution of fibril near and in the area between the fibers. This provides embodiments that are more uniform in their light properties.

FIG. 7B is an end view of several island in the sea fibers 10 that have been melt fused together to form a melt fused bonded fiber and embedded in a polymer 71. Melt fusing of the fiber allows the sea polymer to melt and join the individual fibers together. This is one means of processing fiber useful in this invention into solid films. When used in display applications, having uniform films with both physical and optical properties will help provide the viewing requirements necessary to satisfy the end customer.

FIG. 8 is a top view of an optical film 80 formed from a woven fabric with a high thread count that has been fused together so as to fill the interstices between the polymeric polarizing fiber 83. The cross weft fibers 81 have also been fused to the polarizing fibers. Weaving a fabric with both island in the sea fibers that are polarizing as well as an isotropic fiber is useful because it allow the fibers to be formed into a continuous long web that is useful in roll to roll manufacturing. The cross weft fibers may be woven in a pattern to minimize their visual presents. The fibers are called isotropic and should have little or no birefingence and should have a very good match to the continuous phase sea polymer to assure the highest transmission and reflection properties. In other embodiments similar to this one, the weft fiber could be somewhat birefringent as long as after it is processed into a solid film such as by melt-fusing the weft fibers and the sea polymer together. In this case the Tg of the weft fiber is lower than the fibril polymer and the same or substantially the same as the sea polymer. By heating the fabric the relative amount of birefringence may be reduced to provide a higher delta between this polymer phase and the fibril polymer. The cross weft fibers 81 are transparent and match the continuous phase surrounding the fibrils and therefore are invisible to light transmitting through or reflecting from the surface.

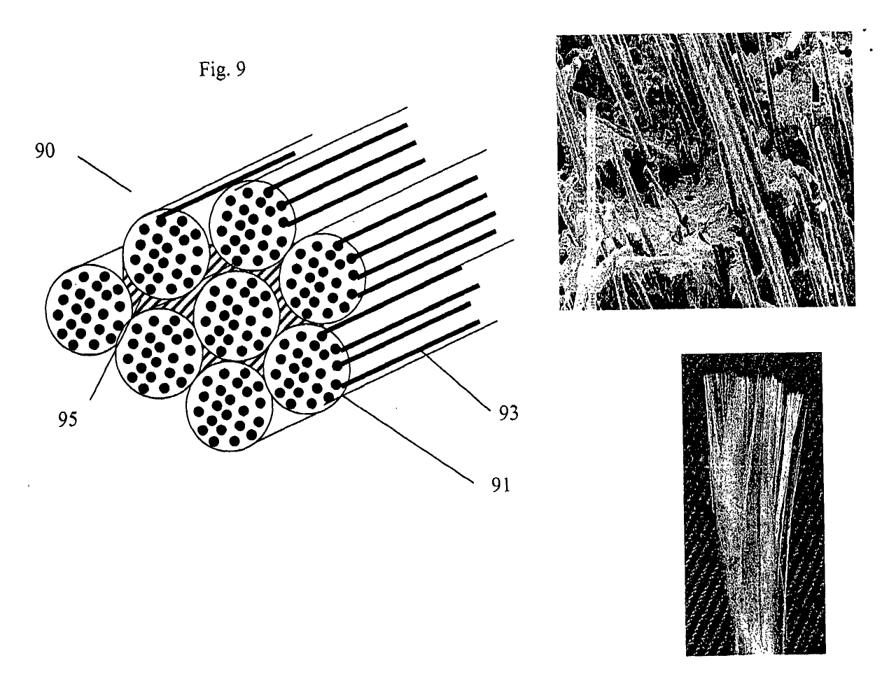

FIG. 9 is a bundle of island in the sea fibers 91 with internal fibrils 93 embedded in a sizing material 95. When processing fibers that are formed into a bundle such as a yarn, the application of a sizing agent is useful in holding the individual filaments together and to minimize fraying. Loose filament may tend to change their alignment position relative to the other filaments in the yarn. Such a filament will have a different axis of polarization than the other and may result in a lower efficiency film.

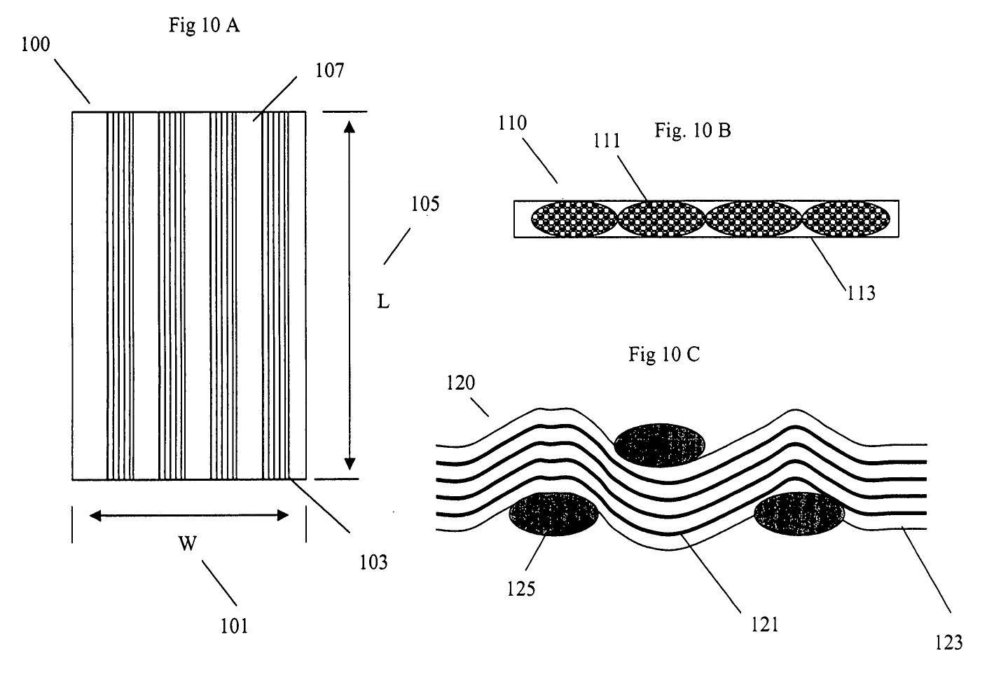

FIGS. 10A,B and C provide a variety of views of a woven polarizer to demonstrate the relative degree of parallelism of the fibrils in a woven polarizing element. FIG. 10 A is a top view of a woven diffuse reflecting polarizing sheet 100 in which the polymeric fiber with internal fibrils 103 are parallel to each other in the width direction 101throught their length direction 105. FIG. 10 B is an end view of the width dimension of a woven diffuse reflecting polarizing sheet 110 that has been melt fused together. Polymeric fiber 111 has the internal fibrils parallel to each other. The polymeric fibers are embedded in sea polymer 113. FIG. 10C is a side view of the length dimension of a diffuse reflecting polarizing sheet 120 in which the fibrils 121 are essential parallel to each other with the sea polymer 123 but change their relative position in their height as a result of the interlacing with isotropic fibers 125.

While most of the previous island in the sea fibers have shown continuous fibrils in their length direction, it should be noted that fibrils that are continuous in their length direction are useful embodiments. FIG. 11 is a 3D view of bi-component fiber 130 with internal fibril 131 with a sea polymer133 between the fibrils. The fibril 131 was made with an immiscible blend of polymer to form a non-continuous segment 135 surrounded by a matrix polymer. The fibrils shown are may have other shapes depending how fibrils are formed and in which direction they are stretched. Discontinuous fibrils are useful because they do not require the same degree of alignment as continuous fibrils. Discontinuous fibrils can be formed to be very plate-like to improve their optical properties. By performing the shape into a more elongated-like shape prior to stretching will help to assure excellent sub-micron domains after stretching. A further embodiment not shown in this figure but also useful would be form an island in the sea fiber that have two more polymer in the sea polymer as well as two or more polymers in the fibrils. Such an embodiment would provide more optical interface to further improve optical performance of the fiber and also the resulting film have processing.

It is, therefore, an object of the present invention to improve the optical efficiency of polarized displays, especially direct view liquid crystal displays (LCDs).

It is a further object of the present invention to provide this efficiency increase while retaining wide viewing angle capability and minimize the introduction of chromatic shifts or spatial artifacts.

It is a further object of the present invention to reduce the absorption of light by polarized displays, minimizing heating of the displays and degradation of the display polarizers.

It is a further object of the present invention to provide an LCD having increased display brightness.

It is yet a further object of the present invention to reduce the power requirements for LCD backlight systems.

It is yet a further object of the present invention to improve display backlight uniformity without sacrificing performance in other areas.

It is still a further object of the present invention to achieve these objects by using a process that enables a cost-effective means to produce an efficient reflective polarizer for use in LCD backlight systems.

Cost-effectiveness is achieved by utilizing a unique island-in-the sea fiber design and a unique extrusion process to create a diffusely reflective polarizer.

### Definitions:

The terms “specular reflectivity”, “specular reflection”, or “specular reflectance” Rₛ refer to the reflectance of light rays into an emergent cone with a vertex angle of 16 degrees centered around the specular angle. The terms “diffuse reflectivity”, “diffuse reflection”, or “diffuse reflectance” refer to the reflection of rays that are outside the specular cone defined above. The terms “total reflectivity”, “total reflectance”, or “total reflection” refer to the combined reflectance of all light from a surface. Thus, total reflection is the sum of specular and diffuse reflection.

Similarly, the terms “specular transmission” and “specular transmittance” are used herein in reference to the transmission of rays into an emergent cone with a vertex angle of 16 degrees centered around the specular direction. The terms “diffuse transmission” and “diffuse transmittance” are used herein in reference to the transmission of all rays that are outside the specular cone defined above. The terms “total transmission” or “total transmittance” refer to the combined transmission of all light through an optical body. Thus, total transmission is the sum of specular and diffuse transmission. In general, each diffusely reflecting polarizer is characterized by a diffuse reflectivity R_{1d}, a specular reflectivity R₁ₛ, a total reflectivity R₁ₜ, a diffuse transmittance T_{1d}, a specular transmittance T₁ₛ, and a total transmittance T₁ₜ, along a first axis for one polarization state of electromagnetic radiation, and a diffuse reflectivity R_{2d}, a specular reflectivity R₂ₛ, a total reflectivity R₂ₜ, a diffuse transmittance T_{2d}, a specular transmittance T₂ₛ, and a total transmittance T₂ₜ along a second axis for another polarization state of electromagnetic radiation. The first axis and second axis are perpendicular to each other and each is perpendicular to the thickness direction of the diffusely reflecting polarizer. Without the loss of generality, the first axis and the second axis are chosen such as the total reflectivity along the first axis is greater than that along the second axis (i.e., R₁ₜ>R₂ₜ) and the total transmittance along the first axis is less than that along the second axis (i.e., T₁ₜ<T₂ₜ).

Diffuse reflectivity, specular reflectivity, total reflectivity, diffuse transmittance, specular transmittance, total transmittance, as used herein, generally have the same meanings as defined in U.S. Pat. Nos. 5,783,120 and 5,825,543.

### Figure of Merit (FOM)

The diffusely reflecting polarizers made according to the present invention all satisfy

R_{1d}>R₁ₛ Equation (1)

T_{2d}>T₂ₛ. Equation (2)

FOM≡T₂ₜ/(1−0.5(R₁ₜ+R₂ₜ))>1.35 Equation (3)

The equations (1) and (2) mean that the reflecting polarizers of the present invention are more diffusive than specular. It is noted that a wire grid polarizer (available from Moxtek, Inc., Orem, Utah), a multilayer interference-based polarizer such as Vikuiti™. Dual Brightness Enhancement Film, manufactured by 3M, St. Paul, Minn., or a cholesteric liquid crystal based reflective polarizer is more specular than diffusive.

Equation (3) defines the figure of merit FOM≡T₂ₜ/(1−0.5(R₁ₜ+R₂ₜ)) for the diffusively reflecting polarizer and the figure of merit FOM is greater than 1.35. For polarization recycling, what matters is the total reflection and total transmission, so only total reflection and total transmission are used to compute the FOM for the purpose of ranking different reflective polarizers. The figure of merit describes the total light throughput of a reflective polarizer and an absorptive polarizer such as a back polarizer used in an LCD, and is essentially the same as equation (1)

$$T 1 = \frac{{T}_{p}}{1 - 0.5 ( {R}_{s} + {R}_{p} ) R}$$

discussed in U.S. Patent Application Publication No. 2006/0061862, which applies to LCD systems where the light recycling is effected using a diffusive reflector or its equivalent. It is noted that R accounts for the reflectivity of the recycling reflective film, or the efficiency associated with each light recycling. In an ideal case, R is equal to 1, which means that there is no light loss in the light recycling. When R is less than 1, there is some light loss in the light recycling path. It is also noted that other forms of figure of merit can be used, however, the relative ranking of the reflective polarizers remain the same. For the purpose of quantifying and ranking the performance of a reflective polarizer, FOM≡T₂ₜ/(1−0.5(R₁ₜ+R₂ₜ)) will be used in this application. The extinction ratio T₂ₜ/T₁ₜ or R₁ₜ/R₂ₜ may not be proper to describe a reflective polarizer because a reflective polarizer having a higher T₂ₜ/T₁ₜ or R₁ₜ/R₂ₜ may not necessarily perform better than one having a lower extinction ratio. For an ideal conventional absorptive polarizer, T₂ₜ=1, R₁ₜ=R₂ₜ=0, so FOM=1. For an ideal reflective polarizer, T₂ₜ=1, R₁ₜ=1, and R₂ₜ=0, so FOM=2.

Sea polymer is also referred to as a continuous phase polymer

Fibrils may also be referred to as a discontinuous phase polymer

The term fibril is defined as a material phase in a fiber that is discontinuous in the cross sectional plane of the fiber but either continuous in the fiber length direction or otherwise elongated to a dimension in the fiber length direction at least 100 times greater than the largest dimension in the cross section plane.

Extrusion melting temperature is defined here as a temperature at which the viscosity of the melted polymer is in a range that enables processing at reasonable pressures, and will be defined here as approximately 100 degrees C. above the glass transition temperature of the polymer.

Onset melting temperature is defined here as the temperature near the melting point of the polymer at which thermal energy is first observed to be seen imparted to the birefringent polymer fibril when heating it up during a standard differential scanning calorimeter measurement.

### Additional Fiber Description

Fibers and fibrils are described in cofiled US application under Attorney Docket No. 92413/AEK, the contents of which are incorporated herein by reference. Polymeric fibers useful in this invention may be at least monofilament Preferably the polymeric fibers are at least bi-component with at least two different materials as well as a physical difference in which one material forms fibrils internal to the fiber or filament. In some embodiments there may at least a third polymeric material.

Polymeric fibers useful in this invention may be two or more fibers formed, wound, or sized to form a yarn.

Yarn is two or more fibers or filaments formed, loosely wound, gathered together, sized or even fused together. Several fibers that are fused or joined together may form a ribbon-like yarn. The yarn may a variety of shapes including but not limited to round, twisted helix shape, square, or ribbon-like.

Ribbon-like for the purposes of this patent refers to a flat structure with four sides. Two of the sides are longer than the other two and typically may have a width to thickness ratio of between 4-1 and 8-1.

Sheet—a structure that is made at the width of the desired end article.

A sheet may comprise 2 fibers or yarns or more but more likely several hundred or even thousands that have been joined together by fusing or embedding in a polymeric material

Sizing refers to the addition of material or surface charge to one or more fibers to minimize fraying during processing the fiber. Sizing provides a means to lightly joining or adhering several fibers together. Ideally the sizing material will have a refractive index that is the same as or substantially the same as one of the optical axes of the continuous phase polymer after the same have been fused together.

Sizing is useful in minimizing filament that may fray or otherwise have their positional alignment changed from the bulk of the yarn.

Fusing typically refers to joining one or more fibers, ribbons, layer, or sheets into an integral mass. This may include but is not limited to melting or dissolving all or part of the continuous phase of the fiber and then causing them to form an integral mass by having the continuous phase solidify.

Embedding the fiber is a process of adding one or more materials to one or more fibers and then allowing the material to harden.

The fibers useful in this invention may be woven in a fabric with the polarizing fibers in one direction and an isotropic fiber in the cross direction. The fabric may be further processed by melt fusing it or embedding it in a polymer to form a film. Additionally fibers useful in this invention may also be wound parallel to each other in at least a single layer of thickness to a desired width, fused or otherwise joined together, filling and leveling any space between the joined fibers to form a film. Auxiliary heat and or pressure may be applied to provide a smooth film. In another methods, the fiber may be cut to a short length, dispersed into a polymer matrix and then cast into a layer with shear forces that align the fibers in a parallel manner.

The polarizing screen (film) of the present invention is a reflective polarizer that is useful in recycling light that is otherwise rejected by the LC layer. This effectively allows for enhanced optical performance and increased light (brightness) entering the LC layer.

Since the reflective polarizing film that is formed by this invention is made by joining several independent fibers and or ribbons together to form integral optical films, it may be useful to dispose one or more auxiliary polymeric layer on top or bottom of the optical film. Such a polymeric material may be melt or solution processable. Such a layer helps to improve the optical and physical integrity of the optical film. Creating a level surface for both incoming and exiting light improves the overall film efficiency and reduce scattering. In addition, the auxiliary layer(s) may provide additional physical properties such as improved bending stiffness, improved thermal coefficient of expansion or improved dimensional stability, improved physical integrity, smoothness, or control of roughness or surface texture or patterning to provide enhanced or different optical functionality.

### Article

One embodiment useful in this invention is an optical element comprising a film containing a layer including continuous phase and discontinuous phase materials, wherein the discontinuous phase materials are fibrils and include a birefringent material having a different refractive index in the orthogonal X and Y directions in a plane perpendicular to the direction of light travel. This optical film provides improved polarizing over other films known in the art. It has a high degree of transparency to at least one polarizing state while having high reflectance of the other polarizing state. This ability to let some light through while rejecting and then recycling light from the other polarizing state provides for improved brightness and overall light efficiency. In another embodiment the optical element useful in this invention comprising a film containing a layer including continuous phase and discontinuous phase materials, wherein the discontinuous phase materials are fibrils and include a birefringent material having a different refractive index in the orthogonal X and Y directions in a plane perpendicular to the direction of light travel wherein said film has the diffuse reflectivity of said discontinuous phase material and continuous phase material taken together along at least one axis for at least one polarization state of electromagnetic radiation is at least about 50%, the diffuse transmittance of said discontinuous phase material and continuous phase material taken together along at least one axis for at least one polarization state of electromagnetic radiation is at least about 50%. The higher the level of transparency to the one polarizing state and the higher the reflectance of light in the other polarizing state improves the overall efficiency of the film.

In a further embodiment the optical element comprising a film is used in an LCD display. The optical element provides improved brightness by recycling light from one polarization that would otherwise be absorbed or scattered by the liquid crystals. When light from one polarization is reflected by the film, it hits another surface and the subsequent light is re-polarized with both s and p state of polarization. This light re-enters the optical element of this invention and approximately half of that light is transmitted and the other half is again recycled. Therefore there is a net gain in the overall light transmission.

The optical element that is used in an LCD display that is useful in this invention is used in combination with a variety of other films or elements such as a slab diffuser, a bottom diffuser, a light efficiency film (continuous or discrete elements), a light modulating valve and a color filter array. The use in combination with one or all of these films helps to provide the proper light management for an LCD display.

The diffusely reflecting polarizer (optical element) comprise two materials containing a layer including continuous phase and discontinuous phase materials, wherein the discontinuous phase materials are fibrils and include a birefringent material having a different refractive index in the orthogonal X and Y directions in a plane perpendicular to the direction of light travel. The relative difference in birefringence helps to improve the overall performance of the film for polarization recycling. The optical element useful in the embodiment in this invention may have a refractive index of the continuous and the discontinuous phase in the X and Y directions of the fibers that comprise at least two components that are within 0.02 of each other.

Some materials that are useful in this invention for the continuous phase may include from the group consisting of polyester, an acrylic, or an olefin and copolymers thereof. The continuous phase comprises polyethylene(terephthalate), poly(methyl-methacrylate), poly(cyclo-olefin), or and copolymers thereof. Additional embodiments may include poly(1,4-cyclohexylene dimethylene terephthalate).

Material that are useful in this invention for discontinuous phase birefringent fibrils comprises polyester and more specifically the polyester may comprises polyethylene(terephthalate), polyethylene(naphthalate), or a copolymers thereof including but not limited to polyethylene(terephthalate) or polyethylene(naphthalate).

A more complete disclosure of materials for continuous/discontinuous phases is cited below. Many different materials may be used as the continuous or discontinuous phase in the optical element of the present disclosure, depending on the specific application to which the optical element is directed. Such materials include inorganic materials such as silica-based polymers, organic materials such as liquid crystals, and polymeric materials, including monomers, copolymers, grafted polymers, and mixtures or blends thereof. The exact choice of materials for a given application will be driven by the desired match and mismatch obtainable in the refractive indices of the continuous and discontinuous phases along a particular axis, as well as the desired physical properties in the resulting product.

However, in one embodiment, the materials of the continuous phase will generally be characterized by being substantially transparent in the region of the spectrum desired.

A further consideration in the choice of materials is that the resulting product contains at least two distinct phases in an exemplary embodiment. This may be accomplished by casting the optical material from two or more materials which are immiscible with each other. Alternatively, if it is desired to make an optical material with a first and second material which are not immiscible with each other, and if the first material has a higher melting point than the second material, in some cases it may be possible to embed particles of appropriate dimensions of the first material within a molten matrix of the second material at a temperature below the melting point of the first material.

The resulting mixture can then be cast into a film, with or without subsequent orientation, to produce an optical device.

Suitable polymeric materials for use as a birefringent phase include but are not limited to materials with positive birefringence, particularly birefringent polyesters, and more particularly birefringent polyesters with naphthalene carboxylate functionality.

Suitable materials for the continuous phase (which also may used in the discontinuous phase in certain constructions) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4, 4!.bibenzoic acid), or materials made from the corresponding esters of the aforementioned acids (i.e., dimethylterephthalate).

Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters are particularly suitable. PEN and PET are especially suitable because of their strain induced birefringence, and because of their ability to remain permanently birefringent after stretching. PEN has a refractive index for polarized incident light of 550 nm wavelength which increases after stretching when the plane of polarization is parallel to the axis of stretch from about 1.64 to as high as about 1.9, while the refractive index decreases for light polarized perpendicular to the axis of index of refraction along the stretch direction and the index perpendicular to the stretch direction) of 0.25 to 0.40 in the visible spectrum. The birefringence can be increased by increasing the molecular orientation. PEN may be substantially heat stable from about 150 C. up to about 230° C., depending upon the processing conditions utilized during the manufacture of the film.

As noted above, the first and second polymers are selected such that the indices of refraction of the continuous and disperse phases are substantially matched (i.e., differ by less than about 0.05) along two of three mutually orthogonal axes, and are substantially mismatched (i.e., differ by more than about 0.05) along the other mutually orthogonal axis.

Therefore, in one embodiment, the second (i.e. non-birefringent) polymer in the film construction has a refractive index selected to provide a minimum block state transmission and maximum pass state transmission at normal incidence. Additional considerations for selecting the second polymer include thermal melt stability, melt viscosity, UV stability, cost and the like. In one example, when PEN is used as one phase in the uniaxially stretched optical material of the present disclosure, the other phase is selected from substantially non-birefringent thermoplastic polymeric materials having refractive indices of about 1.53 to about 1.59, preferably about 1.56 to about 1.58, and more preferably about 1.57.

Suitable materials for the second polymer in the film construction include materials that are substantially non-positively birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designation MS 600 (50% acrylate content) from Sanyo Chemical Indus., Kyoto, Japan, NAS 21(20% acrylate content) and NAS 30 (30% acrylate content) from Nova Chemical, Moon Township Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC) , and polychioroprene.

The optical element useful in this invention that forms a diffusely reflecting polarizer wherein the discontinuous phase materials that has a melting temperature different than the melting temperature of the polymeric continuous phase. By providing a melt temperature difference, a process of melt fusing may be used in the course of fabricating the optical element. Bi or multi-component fibers that are useful in this invention may have discontinuous phase materials as fibrils and a surrounding sea polymer as a continuous phase wherein the phases include birefringent material having a different refractive index in the orthogonal X and Y directions in a plane perpendicular to the direction of light travel. In a process of making the optical elements in this invention where heat is applied, the outer sea polymer may be adjusted in it degree of birefringence by heating it near it melting point. The crystal structure in the polymer is dissolved and therefore the birefringence difference may be adjusted. This is useful because it allows various materials to be used that otherwise would not provide sufficient polarization to be useful in an LCD display.

In one embodiment, the number of fibrils in said polymeric fiber is greater than 50 and in a further embodiment the number of fibrils is greater than 500 and in yet another embodiment, the number of fibrils is greater than 1000. Being able to control and adjust the number of fibril provides a means of being able to tune the resulting optical element to the amount or degree of polarization within the electromagnetic spectrum. Another useful control point is to control the size and geometry of the fibrils as well as the spacing between the fibril.

The optical element comprising useful in the embodiments of this invention may have fibrils each with a cross sectional area of less than 3 square microns while other embodiments have fibrils where the cross sectional area of less than 0.6 square microns. In yet another embodiment, the optical element comprises fibrils each with a cross sectional area of less than 0.2 square microns. Fibrils with a surface area greater than 3 square microns will still provide some degree of polarization recycling provided their optical thickness is between 90 to 1000 nm. It is also desirable to control the optical spacing between fibrils in the thickness dimension to a similar thickness of between 90 to 1000 nm. For the most efficient films it is desirable to have substantially all of the fibrils and Z dimension (thickness) spacing between them within this range. Useful but slightly less efficient films may have a higher percentage of fibrils thickness and the spacing between them outside of the range of between 100 to 2000 microns. Increased number of interface will result in improved reflection while fewer interfaces will improved the transmission of the resulting optical element. To provide the optimal film for reflective polarization the number, the size and shape of the fibril and the thickness spacing between the fibrils need to be balanced as well as the selection of materials and the resulting process to make the fibers. The process to make the optical element need to be adjusted to control the ordinary refractive index for transmission properties and the extraordinary refractive index for reflective properties.

In useful embodiments in this invention the ratio of discontinuous phase to continuous phase on a weight basis is less than 2 to 1. Higher amounts of discontinuous phase material in the fibrils will increase the resulting films reflection. In other embodiments where increasing transmission is desired the ratio of discontinuous phase to continuous phase on a weight basis is less than 0.8 to 1 and in these case where even higher transmission is desired the ratio of discontinuous phase to continuous phase on a weight basis is less than 0.3 to 1.

The shape or geometry of the fibers and the fibrils that are use to make some of the embodiments of this invention are useful tools to help optimize the transmission and reflection properties of the optical element. The optical element may comprise birefringent fibril discontinuous polymeric phase that have a cross-sectional shape that is circular, rectilinear, elliptical, triangular, tri-lobal, or trapezoidal. Circular (radical) shaped fibrils tend to collimate light, rectilinear and in particular flat ribbons-like shapes are useful in providing interfaces between the fibrils and the continuous phase polymer that are more uniform. Elliptical shapes are useful in spreading light in a slightly wider angle. When viewing films with fibrils in an end cross sectional view, there may be hundreds or thousands of fibrils in a staggered overlapping configuration. It is desirable to have the fibrils overlap at least one or more other fibrils.

The multi-component fibers themselves may also have a shape that is circular, rectilinear, elliptical, triangular, tri-lobal, or trapezoidal. The individual fiber shape is useful in allowing many fibers to be fused together in which the interstices can be filled more uniformly and therefore provide an optical element that is more uniform and is less likely to scatter light. In other embodiment useful in this invention the shape of the multi-component fiber and the internal fibrils may have any combination. In particular, a flat ribbon multi-component fiber that also has flat ribbon-like fibrils help to optimize the ability to provide uniformly fused fibers as well as fiber that provide uniform light reflection and transmission.

In the formation of the optical element useful to provide reflective polarization, the fibrils are aligned to be substantially parallel in relation to each other in their length dimension. In some embodiments the fibrils are parallel to each between 0 to 45 degrees. Zero degrees refers to the fact that they are parallel. As the angle of the between fibrils increases, the efficient of the film will decrease. In a preferred embodiment the fibrils are between 0 to 15 degrees and in the most preferred embodiment the fibrils are parallel form 0 to 5 degrees.

Another useful embodiment of this invention provides an optical element comprising a film containing a layer including continuous phase and discontinuous phase materials, wherein the discontinuous phase materials are discontinuous fibrils in their length dimension (domains) dispersed in an immiscible phase with the same refractive index as the continuous phase polymer and include a birefringent material having a different refractive index in the orthogonal X and Y directions in a plane perpendicular to the direction of light travel. Such an embodiment provides a means to perform the domains with a fibril and adjust their relative thickness prior to stretching. Such domains can be very thin and plate-like and after stretching they may form very thin disc like domains that are efficiency in transmitting one phase of polarized light and reflecting the other phase of subsequent recycling.

A useful end-use embodiment of this invention provides a display comprising a diffusely reflecting polarizer film comprising containing a layer including continuous phase and discontinuous phase materials, wherein the discontinuous phase materials are also discontinuous fibrils in their length dimension, dispersed in an immiscible phase polymer with the same refractive index as the continuous phase polymer and include a birefringent material having a different refractive index in the orthogonal X and Y directions in a plane perpendicular to the direction of light travel. The use of this and other embodiments in this invention may further comprises at least one function selected from the group consisting of image viewing screen, antireflection layer, ambient light suppression, color filter array, light valve, illumination enhancement, light collimtion, light directing, light diffusion, stiffening, resistance to thermal expansion, light spreading, a light source, image algorithm, image storage, image buffer, optical brightener, IR reflection and a power source.

Other useful embodiments provide an optical element with the continuous and or discontinuous phases that has a blend of two or more polymers. The use of more than of polymer provides a means to provide a high degree of birefringence separation between the two of the polymers but matching a third in used. Other optical element embodiments provide a blend of polymers where one of two or more polymers is immiscible in the other polymer. Such a blend is useful in further forming thin polymer domains when they are stretched. In yet another embodiment the optical elements of this invention have discontinuous phase fibrils in their length direction and contain an immiscible blend of at least two polymers and wherein at least one of the two polymers has the same amount of birefringence as the continuous phase. By matching one phase of birefringence, the optical efficiency of the optical element is enhanced. In other embodiments the polymeric material used to fill the interstices between fibers is the same material of at least one of the discontinuous or continuous phase polymers. This provides a good match of refractive index and birefringence and therefore is useful in optimizing the transmission and or reflection properties.

In other embodiments where a different material is used to fill the interstices between fibers, the different has the same refractive index of at least one of said discontinuous or said continuous phases. Providing in at least one optical plane, a higher degree of transparency is achievable. When a different material is used to fill the interstices between fibers it may be selected from the group consisting of a radiation crosslinkable monomer, a chemically crosslinkable material, a solution polymer or a melt polymer. UV monomers can be flowed in between the fibers and quickly cured to form a hard surfaced films. Chemically crosslinked materials such as epoxies can be formulated to easily flow between the fiber and then form a very hard, tough and durable film-like structure. Other means available but not limited are to extrude a layer onto the embodiment of interest or coat it with a solution polymer.

When forming discontinuous fibrils for the useful embodiments of this invention they fibril-like domains are aligned parallel to within 0 to 45 degrees of each other. (0 degree is parallel) and in other embodiments the fibrils are parallel to within 0 to 15 degrees of each other. In a preferred embodiment the fibrils are parallel to within 0 to 5 degrees of each other. The higher the amount of parallelism, the sharper the polarization effect and the resulting optical element has a higher efficiency.

### General Process Disclosure for the Article

The optical element of this invention may be formed by a number of processes including but not limited to:
a) Fiber making: The present invention provides a process for producing a diffusive reflective polarizing film made up of a composite of birefringent polymeric fibrils dispersed in an isotropic polymeric phase. The birefringent fibrils are created by producing multi-component island-in-the-sea fibers whereby the birefringent fibrils are islands in a sea of a continuous polymeric phase and wherein the refractive index of the continuous phase in the X and Y directions are substantially matched and wherein the extrusion melting temperature of the continuous phase is less than the onset melting range of the discontinuous phase.
b) A process for making a diffusely reflecting polarizer comprising the steps of:
   1) providing polymeric fibers that comprise discontinuous phase birefringent fibrils substantially parallel to each other and dispersed in a polymeric continuous phase;
   2) arranging the fibers in a substantially parallel array;
      A) Weaving fibers
      B) Winding fibers on a drum or form
      C) Conveying the fibers into a melt or solvent (may include aqueous materials) casting nip
   3) forming the fiber array into a continuous solid film wherein the interstices between fibers are filled with polymeric material.
      A) heat or solvent fusing the continuous phase polymer so they adhere together.
      B) adding additional polymer so as to level the interstices between the fibers

The above-described process for winding and or weaving is described in more detail in the process section above.

Diffusely reflective polarizer films produced as described above can be used in liquid crystal displays (LCD's) to more efficiently utilize light emitting from a backlight system. Although the placement of the diffusely reflective polarizer is not limited it typically is placed between the back light unit and the liquid crystal panel comprising liquid crystal polymer between two absorptive polarizers.

### Fiber Description

Many items are made from synthetic fibers. Conventionally, two processes are used to manufacture synthetic fibers: a solution spinning process and a melt spinning process. The solution spinning process is generally used to form acrylic fibers, while the melt spinning process is generally used to form nylon fibers, polyester fibers, polypropylene fibers, and other similar type fibers. As is well known a polyester fiber comprises a long-chain synthetic polymer having at least 85 percent by weight of an ester of a substituted aromatic carboxylic acid unit.

The melt spinning process is of particular interest as since a large portion of the synthetic fibers that are used in the textile industry are manufactured by this technique and the process is ubiquitous at production scale. Also, since the present invention also requires unique down stream extrusion processing of the fibers to produce a composite film with oriented fibrils, melt spun fibers are desirable. The melt spinning process generally involves passing a molten polymeric material through a device that is known as a spinneret to thereby form a plurality of individual synthetic fibers. Once formed, the synthetic fibers are typically collected into a strand or cut into staple fibers. Synthetic fibers are typically used to make knitted, woven, or non-woven fabrics, or alternatively, synthetic fibers can be spun into a yarn to be used thereafter in a weaving or a knitting process to form a synthetic fabric. Multi-component fibrils have been well demonstrated in previous disclosures. Such fibers comprise two or more polymers and typically are designed to either split apart due to incompatibility of the polymers or one polymer is dissolved in solvent such that smaller fibrils of the other polymer are left. This method results in much smaller fibers or fibrils than can be traditionally produces via mono-component fiber processes and offers a wider range of final properties of the fiber-based article in which the fibers are used. The present invention relates to a multi-component fiber having both a birefringent polymeric fibril component as well as a continuous polymeric phase component with a melt processing temperature lower than the onset melting temperature of the birefringent fibril.

In order to make the fiber composite film of the present invention effective as a reflective polarizer it is desirable to create many small fibrils within a fiber such that many more optical interfaces can be created in a given thickness of film when dispersed by the process of the present invention into a composite film. Processes to create fibers with many small fibrils, also known as, island-in-the sea fiber making processes are well known in the trade. In particular the processes as described in U.S. Pat. Nos. 5,162,074 and 5,466,410 utilizing photo-etched plates to control flow of the different polymer melts in the multi-component fiber are very suitable. The use of photo-etched plates is helpful in creating very small fibrils internal to a larger fiber or filament. After the fibers are stretched, the fibrils may have a cross-sectional thickness of less than one micron. Having features that are less than one micron is useful in polarizing light as well as reflecting one polarizing phase of light. The cross sectional shape of the fibers can be of any geometry such as circular, rectilinear, elliptical, triangular, tri-lobal, or trapezoidal. Typically the fiber cross sectional shape will be circular or elliptical with the most common cross sectional shape being circular. Similarly, the cross sectional shape of the fibrils can be of any geometry such as circular, rectilinear, elliptical, triangular, tri-lobal, or trapezoidal. Again, typically the fibril cross sectional shape will be circular or elliptical with the most common cross sectional shape being circular.

While certain representative embodiments and details have been shown for purposes of illustrating the invention, it will be apparent to those skilled in the art that various changes in the designs and methods disclosed herein may be made without departing from the scope of the invention, which is defined in the appended claims.

The birefringent fibrils in the island-in-the-sea fiber of the present invention can comprise any polymer in the general class of polyesters. Typical polyesters for such use can be polyethylene(terephlatate), polyethylene(naphthalate), or any copolymers of either. The most suitable polyester for the birefringent fibril is polyethylene(terephlatate).

The continuous polymeric phase in the island-in-the-sea fiber of the present invention can comprise any polymer in the general classes of polyesters, acrylics, or olefins. Typical polymers for such use can be polyethylene(terephlatate), poly(methyl-methacrylate), poly(cyclo-olefin), or any copolymers of either. The most suitable polymers for the continuous phase is poly(1,4-cyclohexylene dimethylene terephthalate) or poly(ethylene-terephthalate/isophthalate) copolymer.

As mentioned previously the extrusion melting temperature of the continuous polymeric phase of the fibers should be less than the onset melting temperature of the birefringent fibrils. Typically this difference will be greater than 10 C

but is preferred to be greater than 40 C. Most preferably the extrusion melting temperature of the continuous polymeric phase is greater than 75 C below the onset melting temperature of the birefringent fibrils.

The island-in-the sea fibers of the present invention are cold drawn after being melt spun as is typical for such a fiber process. The cold draw is done with the fibers heated to just above the glass transition temperature(Tg) of the fibrils polymer. Typically the cold draw is done at 2 to 20 C above Tg.

The amount of draw or draw ratio, which is the ratio by which the fiber is lengthened relative to its initial length, is important in attaining a high level of birefringence of the fibril. This is important as it creates a large difference in the Z direction(see FIG. 2) extraordinary index of the fibril and the eventual Z direction ordinary index of the continuous phase of the composite film. The Z direction of the continuous phase is melt relaxed during film processing and therefore retains the ordinary index of the continuous phase polymer resulting in an isotropic continuous phase. The large difference in Z direction index of the fibril and the continuous phase is desired as it results in a high degree of reflection of light that passes through the film that is approaching the film orthogonal to the film surface and is linearly polarized parallel to the length of the fibril. The draw ratio should be greater than 2 to 1 and preferably greater than 3 to 1. Most preferably the draw ratio is greater than 3.5 to 1 to maximize the degree of crystallinity and thus birefringence of the fibrils.

The continuous polymeric phase may also become birefringent in the drawing process but this is not critical. Any birefringence of the continuous phase polymer will be signifactely reduced or eliminated during the subsequent melt fusing process when making the composite polarizing film. Therefore drawing temperature is only critical for the continuous phase polymer to the degree that the polymer will stretch at the draw temperature without cracking and/or sticking to the draw rollers.

As mentioned previously, a large number of smaller fibrils in the fibers is preferable as this will ultimately result in many more optical interfaces in the final composite film reflective polarizer. The number of fibrils in the fiber is determined by the design of the spin pack. For a given spin pack design the size of the fibrils is then determined by the relative weight ratio of fibril polymer to continuous phase polymer when melt spinning. Typical weight ratios of fibril polymer to continuous phase polymer is less than 2 to 1 and preferably less than 0.8 to 1. Most preferably the weight ratio of fibril polymer to continuous phase polymer is less than 0.3 to one.

### Materials of Fibers:

There are at least two materials: there is a sea polymer (continuous phase) and a fibril (discontinuous phase).

The materials have a delta birefringence and or refractive index from each other at the time of fiber making. The fibrils are surrounded by a sea polymer. The materials have a delta melting point within the internal fibril material having a higher melting point. The materials have a high degree of transparency and also have a high degree (>80%) of clarity (low or no haze). The fibrils may have any shape desired. The fibers may have any shape. The fibers and fibrils may have a different shape.

The shape is not particularly critical and may be, for example, circular, rectilinear, elliptical, triangular, trilobal, or trapezoidal.

The cross-sectional size of the fibrils may be from 100-1000 nm. The Z direction space separating the fibrils may be from 100-2000 nm. The fibrils are essentially continuous in their length dimension. If the fibril polymer is ablend of more than one polymer and in particular an immiscible blend, it is possible to have the length dimension of the fiber that is not continuous. This is useful in making short fibers that have different optical properties. Typically, the polymeric fibers have a ratio of discontinuous phase to continuous phase on a weight basis is less than 2 to 1.

Once the fibers useful in the embodiments of this invention are made as described above they need to be aligned and further processed into a continuous film. One method that provides the alignment of the fibers is to weave the fibers into a fabric.

### General Weaving Disclosure:

Weaving is an ancient textile art and craft that involves placing two sets of threads, fibers or yarn made of fiber called the warp and weft of the loom and turning them into cloth. The majority of commercial fabrics are woven on computer-controlled Jacquard looms. In the past, simpler fabrics were woven on other dobby looms and the Jacquard harness adaptation was reserved for more complex patterns. The efficiency of the Jacquard loom makes it more economical for mills to use them to weave all of their fabrics, regardless of the complexity of the design.

Fabric consist of fibers (threads or yarns) that run in a horzonital direction which are call the weft fibers and in the vertical direction called the warp. In general, weaving involves the interlacing of two sets of threads at right angles to each other: the warp and the weft. The warp threads are held taut and in parallel order by means of a loom. The loom is warped (or dressed) with the warp threads passing through heddles on two or more harnesses. The warp threads are moved up or down by the harnesses creating a space called the shed. The weft thread is wound onto spools called bobbins. The bobbins are placed in a shuttle which carries the weft thread through the shed. The raising/lowering sequence of warp threads gives rise to many possible weave structures from the simplest plain weave (also called tabby), through twills and satins to complex computer-generated interlacings.

Both warp and weft can be visible for most farbics in the final product. By spacing the warp more closely, it can completely cover the weft that binds it, giving a warpfaced textile such as rep weave. Conversely, if the warp is spread out, the weft can slide down and completely cover the warp, giving a weftfaced textile, such as a tapestry or a Kilim rug. There are a variety of loom styles for hand weaving and tapestry. In tapestry, the image is created by placing weft only in certain warp areas, rather than across the entire warp width. For making a polarizing screen in a woven article, it is desirable to use both the process and the optics of the materials to minimize the viewing of a non-polarizing fiber or thread (isotropic fiber).

Synthetic fibers are manufacutred often by melt extrudung a polymer out of a orfice plate with a hole or slit in it. The fiber is melt drawn in a free fall zone and until it solidifies and then is often “cold” drawn by a series of over speed temperature controlled rollers. The fiber (s) is then wound on a core or bobbin. In severasl fiber are wound together, they are refered to as a yarn. Since most yarns are a lose winding of several fibers (except mono-filaments), they be further processed with a sizing material that helps to hold the fibers together during weaving or winding. Satin weave, twill weaves, and plain weaves are the 3 basic types of weaving by which the majority of woven products are formed. For use in a reflective polarizer one of either the warp of weft fibers is a multi-component fiber with discontinuous phase fibrils surrounded by a continuos phase polymer wherein said continuous and discontinuous phases have a difference in birefrigence and the other cross woven fiber is isotropic (non-polarizing with little or no birefringence). Ideally this fiber has the same refractive index as the continuous phase of the multi-component fiber. In the subsequence process to melt fuse the woven polarizing fabric into a solid film, the interestices are filled when the outer continuous phase of the polarizing fiberfuses with adjacnet fiber as well as the cross woven isotropic (non-polarizing) fiber. Such a weaving process is desiarable because it provides a high degree of alignment (parallelism)for the polarizing multi-component fiber which is desirable for improved efficiency of a reflective polarizer. Additionally the weaving process provides a means towards a roll-to-roll manufacturing process.

### Process Detailed Description (Winding/Weaving-Fusing)

In a preferred embodiment of this invention a process for making a diffusely reflecting polarizer comprising the steps of providing polymeric fibers that comprise discontinuous phase birefringent fibrils substantially parallel to each other and dispersed in a polymeric continuous phase wherein at least one of said continuous and or discontinuous phases are birefringent; a means of arranging the fibers in a substantially parallel array and then forming the fiber array into a continuous solid film wherein the interstices between fibers are filled with polymeric material. The polymeric fibers and internal fibrils provide a unique material that when optimized for their relative difference in birefringence between the continuous and discontinuous phases and the number, shape and size of fibrils in relation to the continuous phase materials provide maximum transmission for one phase of light and maximum reflection for the other phase of light. The process further provides a means of arranging the fibers in a substantially parallel array and forming the fiber array into a continuous solid film wherein the interstices between fibers are filled with polymeric material. Such a continuous solid film provides excellent diffuse polarizing recycling that is useful in a variety of application including LCD displays.

The present invention provides a process for producing a diffusive reflective polarizing film made up of a composite of birefringent polymeric fibrils dispersed in an isotropic polymeric phase. The birefringent fibrils are created by producing multicomponent island-in-the-sea fibers whereby the birefringent fibrils are islands in a sea of a continuous polymeric phase and wherein the refractive index of the continuous phase in the X and Y directions are substantially matched and wherein the extrusion melting temperature of the continuous phase is less than the onset melting range of the discontinuous phase.

One preferred process embodiment that provides for arranging the fibers in a substantially parallel array is a weaving process. In such a process the polymeric fibers that comprise discontinuous phase birefringent fibrils substantially parallel to each other and dispersed in a polymeric continuous phase are aligned in either the vertical or horizontal axis and a second isotropic fiber in the opposite direction that has substantially the same index of refraction has the continuous phase of the polymeric fibers. By substantially matching the index of refraction as the continuous phase, the isotropic fibers are essentially invisible. In a weaving process the fibers in the vertical direction (warp) and the fibers in the horizontal direction (weft) are interlaced at some frequency. For example a series of vertical fiber may have one horizontal fiber on the top surface of one fiber and then a grouping of 5 to 6 fibers in which the horizontal fiber is on the opposite surface of the fabric being woven. The number of top and bottom exposed fibers may be varied to maximize the reflective polarization effect desired. It is also desirable to provide tight fiber-to-fiber packing to assure uniform polarizing in the final film formed from these fibers. A high thread (fiber) count is desirable. Woven fabrics may have one or more layers of fibers. The isotropic fibers are not parallel to the polymeric fibers that comprise discontinuous phase birefringent fibrils substantially parallel to each other and dispersed in a polymeric continuous phase.

In one embodiment of this invention said isotropic fibers are at an angle of between 45 and 90 degrees of said polymeric fibers that comprise discontinuous phase birefringent fibrils substantially parallel to each other and dispersed in a polymeric continuous phase. The primary function of the isotropic fiber is to hold said polymeric fibers together during the weaving process. Since the isotropic fibers are designed to have the same refractive index as the continuous phase of the polymeric fiber and there is little or no birefringence to the isotropic fiber, light hitting these fibers is minimally impacted and has no measurable effect on the reflective polarizing of the film. In general the number of isotropic fiber is kept to a minimum. Since the polymeric fiber and the isotropic are interlaced over each other, it may be desirable to control the geometry of the fibers to minimize their Z-dimensional planar change. This is useful in controlling the tilt of the polarzing fibers and provides the optimal optical properties. The present invention according to one aspect thereof provides a polarizing screen which comprises a woven polarizing fabric having top and bottom surfaces opposite to each other. (Top faces the LC in a display and the bottom is closest to the light source. The top surface may have a different number of polarizing fibers than the bottom surface.

The polymeric fibers that comprise discontinuous phase birefringent fibrils substantially parallel to each other and dispersed in a polymeric continuous phase are polarizing. While the polymeric fibers useful in this invention may have some limited polarizing by themselves the methods used in this invention are useful in converting the continuous phase polymer from a bireflingent material to a material that has little or no birefringence and therefore making a high efficient reflective polarizer. The process of forming the fiber array into a continuous solid film wherein the interstices between fibers are filled with polymeric material provides a means of tuning the birefringence of the continuous phase material in relation to the discontinuous phase material. The polymeric fibers may be melt fused and or solvent fused to joint the individual fibers into a continuous solid film. The melting or solvent dissolving process changes the crystal structure of the polymeric fiber and therefore impact the amount of birefringence of the continuous phase of the polymeric fiber. This process tuning provides a means to maximize the difference between the fibrils and the outer continuous phase. By flowing the outer phase material the fibers are then joined together. This process is done after the individual fibers have been substantially aligned. To provide the optimal reflective polarizing effect the discontinuous phase birefringent fibrils substantially parallel to each other and dispersed in a polymeric continuous phase.

The isotropic fiber useful in this invention are preferable substantially non-birefringent. In some embodiments, the isotropic fibers suitably have a refractive index difference less than 0.02. Having properties in this range makes the isotropic fibers substantially invisible.

Useful polymers for the discontinuous phase birefringent fiber include polyester. The polyester may comprise polyethylene(terephthalate), polyethylene(naphthalate), or a copolymers thereof. The use of these and other materials in the fibrils provides a high degree of birefringence and high refractive when they are stretched. These polymers provide excellent materials for fiber formation because of their high tensile strength during elongation. They are also relative inexpensive and are commercially available. The continuous phase of the fiber (sea polymer) may suitably comprise at least one material selected from the group consisting of polyester, an acrylic, or an olefin and copolymers thereof. These materials include but are not limited to polyethylene(terephthalate), poly(methyl-methacrylate), poly(cyclo-olefin), or and copolymers thereof. One preferred embodiment continuous phase comprises poly(1,4-cyclohexylene dimethylene terephthalate).

In the selection of a material for the continuous phase polymer for use in weaving or fiber winding and subsequence fusing (melt or solvent), there needs to be a difference in relative melt temperature or solubility between the continuous and the discontinuous phases (fibrils). One means to minimize the relative difference would be to include a heat absorbing dye (such as an IR dye) in the continuous phase. This would allow more heat to be absorbed in that layer and it would therefore melt before the other phase not containing the material.

In the process for the formation of a diffusely reflecting polarizer the polymeric fibers and in particular the fibrils are substantially in a parallel array. Since the continuous phase material is melt or solvent fused with adjacent polymeric fibers and they become an integral solid film, only the internal fibrils (within a single fiber and or other fibers in the form continuous solid film) need to be substantially aligned. Within a single fiber, the process of making the polymeric fibers, the polymer of the fibrils is extruded or solvent cast out of a series of predefined spatially oriented orifice plates, the fibrils have a predetermined degree of parallelism between the fibrils. The polymer is stretched an oriented in one direction that reduces the spacing between the fibrils but they essentially remain parallel to each other. The formed polymeric fibers are arranged in a substantially parallel manner by a winding and conveyance process The fibers wound on a rollers or a form. By subjecting the fibers to heat and or pressure, the continuous phase material that has a lower melting point than the fibrils are fused together forming a continuous solid film wherein the interstices between fibers are filled with polymeric material. In another embodiment of this process, additional polymer may be added to either the top surface (away from the drum or form) and or the bottom surface. The addition of a polymer skin of this type is useful because it will help to provide a smooth level surface and therefore reduce unwanted light scattering as well as provide addition strength and stiffness to the continuous solid film. In a preferred embodiment, the polymer skin has an index of refraction that matches the continuous phase of the polymeric fiber. The polymer skin may also have a high degree of transparency unless the polymer in some embodiments or may be diffuse (volume or surface diffuser), or may have a structure or rough surface. The thin polymer skin comprises at least one layer but other layers or features may be added to enhance the overall functionality of the composite film. The polymer skin may have a thickness of between 6 to 400 micrometers and may be applied to either or both the top and bottom surface of the continuous solid film of this invention. It should also be noted that polymer skin may not be detectable after being attached to the continuous solid film. Furthermore it should be noted that a different skin with different properties may be added to either the top and or bottom surfaces of the continuous solid film of this invention. Such skins may be applied by melt extrusion, melt or solvent casting, lamination of a preformed polymer skin and or coating or printing a polymers layer. The polymer skin or sheet forms an integral part of the fiber array that forms a continuous solid film. While the term polymer skin may infer a continuous layer, additional embodiments may have stripes, discrete and continuous features or non-continuous area of skin polymer. The surface of the continuous solid film and or the polymer skin may be have treatments and or primer applied to enhance the overall performance and environmental stability of the final product. Addenda may be added to the skin layer (internal or surface) to enhance light and heat stability, light control such as antireflection, diffusion, collimation or spread of the light either entering or leaving the continuous solid film of this invention. The addenda may be either organic or inorganic.

Another process embodiment of this invention provides a means for arranging the fibers in a substantially parallel array by conveying the multiple fibers in a manner in which adjacent fiber touch each other as they enter a nip in which heat and pressure is applied. In some cases there may be a very slight spacing between the fibers. The space will be filled after the fibers a melt processed. Excessive spacing may result in a lower efficiency film for both optical and physical performance. By forming more than one layer of fibers where one layer is offset with respect to the other but still parallel any space between fiber can be filled with additional optical interfaces formed by the fibrils. Such application of heat and pressure may be directly applied to the polymeric fibers, or may involve the extrusion of a molten polymer skin or casting of solvent containing polymer either one or both surfaces of the fibers. In such a process the continuous phase polymer of the polymeric fiber is melted or partial dissolved to form a continuous solid film wherein the interstices between fibers are filled with polymeric material. As described above in additional materials, features . . . etc may be added to the polymer skins. In an additional embodiment a polymer skim may be laminated to the polymeric fiber using a performed layer. The application of heat may be by direct contact to hot rollers or belts, hot gas blown on he surface, radiant heater, infra-red, microwave, ultrasonic radiation and other methods know in the art. As mention above the use of pressure and in particular pressure applied with a smoother surface will aid in the formation of a density, smooth film. If the fibers are heated on a surface such as a drum or roller, it may be desirable to have the surface of such material to be very smooth so as to provide a smooth surface to the resulting film. The rollers or belt surface may be modified with a release aid (such as Teflon or silicone) so the polymer does not stick to the surface. The temperature of that surface may also be modified to aid in the release and not sticking of the molten polymer to the roller or belt surface. In other embodiments the roller, belt or form may have its physical surface modified to prevent sticking. Such surface modification may involve roughening or creating micro-surface features. The form, roller and or belt may be temperature controlled to aid in quenching the polymer surface as well as in the release of the polymer form the surface.

The process of fusing the fiber may further provide the addition of a polymers at the time of fusing or as an additional step in the process to fill the intertisices between the fibers. Such polymer may be perform layer(s), polymer resin pellet, powderized flakes of polymer, a molten curtain of one or more polymers or solvent based polymer.

In yet another process embodiment of this invention the diffusely reflecting polarizer may have a blend of two or more polymers in at least one of the continuous phase and or the discontinuous phases. In a preferred embodiment there are two or more polymers that are immiscible. In such an embodiment there is a combined effect of spatially predetermined domains as well as regions with the phase that contains further alternating refractive indexes. In such an embodiment there is improved opportunities for reflecting one phase of polarized light. Such an embodiment would be very efficient. In a further embodiment of this invention wherein the discontinuous phase fibrils comprise an immiscible blend of at least two polymers and at least one of the two polymers has the same amount of birefringence as the continuous phase. In such an embodiment with matching refractive indices in the continuous and in a portion of the discontinuous fibril phase, the transmission properties would be greatly enhanced. Furthermore the fibrils would be made such that they are not continuous in the machine direction of the fiber and or of the resulting film that is formed by fusing or otherwise joining the fiber together. Such a discontinuous fibril would be useful in providing a more random interface for reflecting and be useful for broadband reflective polarizers.

In the process of filling the interstices between the fibers a useful embodiment would use the same the polymeric material of at least one of the discontinuous or continuous phase polymers. By using the same material, the refractive index and degree of birefringence or lack thereof would match at least one of the continuous or discontinuous phase polymers. Such an embodiment is useful in optimizing the relative transparency of the resulting film. Such a film would be a highly efficient reflective polarizer.

In another embodiment of this invention the interstices between fibers is filled with a different material than the discontinuous and the continuous phases. In such an embodiment the fiber could be wound in a parallel manner to each other or woven in a polarizing fabric and the fiber could then be embedded in different material. In a useful embodiment of this invention the different material used to fill the interstices between fibers has the same refractive index of at least one of discontinuous or continuous phases. This is useful in assuring a good functioning reflective polarizer in which there is excellent transmission properties. In such a process where the different material used to fill the interstices between fibers, the different material is selected from the group consisting of a radiation crosslinkage monomer, a chemically crosslinkage material, a solution polymer or a melt polymer. Addenda may be added to these materials to adjust their refractive index to match that or at least one of the continuous or discontinuous phases. UV curable monomer are useful because they can be easily applied to the fibers in a manner that fills the interstices and the monomer can be quickly crosslinked to form a hard rigid film. In this case the material selected for the fibers may have at least one of the continuous and or discontinuous phases from a similar chemical classification as the UV material. These typically are acrylates and other copolymers of acrylates. Chemically crosslinked epoxies may also be use to fill the interstices as well as melt and solution polymers.

In the process for making a diffusely reflecting polarizer that comprises polymeric fibers that comprise discontinuous phase fibrils substantially parallel to each other and dispersed in a polymeric continuous phase that are arranged in a substantially parallel array and then formed into a continuous solid film wherein the interstices between fibers are filled with polymeric material, the polymeric fiber may comprise more than 50 fibrils. Other useful embodiments in this invention comprise more than 500 fibrils while other comprise more than 1000 fibrils. The number of interfaces, the relative area, the shape, the relative refractive index mismatch between the fibrils and the continuous phase are factors that may influence the amount of transmission and reflection of light. In a general sense the few the number of interfaces, the more transmissive the film will be and the higher number of interfaces the more reflective the film. Since the optimal properties of the films of this invention are determine by a variety of complex properties of the discontinuous phase fibrils and the continuous phase polymer it may be useful to state the each fibril have a cross sectional area of less than 3 square microns. In those embodiments in which more transmission is desired each fibril may have a cross sectional area of less than 0.6 square microns while in other embodiments each fibril may have a cross sectional area of less than 0.2 square microns.

The polymeric fibers useful in one embodiment of this invention have a ratio of discontinuous phase to continuous phase on a weight basis is less than 2 to 1 wile other embodiments have a ratio of discontinuous phase to continuous phase on a weight basis is less than 0.8 to 1. In a preferred embodiment, the polymeric fibers have a ratio of discontinuous phase to continuous phase on a weight basis is less than 0.3 to 1.

In the course of making the polymeric fiber that are useful in the embodiments of this invention, the fibers are cold drawn to achieve a high level of birefringence of the discontinuous phase. The drawing process provides a degree of birefringence in both the discontinuous phase fibril polymers and depending on the material a degree of birefringence in the continuous phase polymer. The difference in birefringence between the two phases helps to determine the amount of polarizing that the fibers provide. Many polymers combinations are not sufficiently polarizing after drawing or may lack sufficient clarity. The unique part of the embodiments of this invention is that the continuous phase polymer birefringence is changed (lower or eliminated) during the fusing process. The birefringence of the fibrils in not altered. The stretchedfiber with internal fibrils is highly polarizing. In one embodiment the fibers are cold drawn at least 2 to 1. In another embodiment of the process useful in this invention, the fibers have been cold drawn at least 3 to 1 and in a preferred embodiment that are cold drawn at least 3.5 to 1.

The amount of drawing that a polymer will tolerate is dependant on melt drawing properties such as its elongation to break strength. For high levels of polarizing it is desirable to stretch the polymer used in the fibril as much as possible to maximize its birefringence. While the continuous phase polymer will develop its own birefringence, the melt fusing process will relaxed it out and the resulting difference between the continuous and discontinuous phase polymers results in a high degree of polarizing while obtaining good transmission for one polarization phase and good reflectance for the other polarization state.

The shape and size of the polymeric fiber as well as the shape of the internal fibrils can also impact the amount of transmission and reflectance achieved by the solid film formed by the process of this invention. The shape or geometry of the fibers and the fibrils that are use to make some of the embodiments of this invention are useful tools to help optimize the transmission and reflection properties of the optical element. The optical element may comprise birefringent fibril discontinuous polymeric phase that have a cross-sectional shape that is circular, rectilinear, elliptical, triangular, tri-lobal, or trapezoidal. Circular (radical) shaped fibrils tend to collimate light, rectilinear and in particular flat ribbons-like shapes are useful in providing interfaces between the fibrils and the continuous phase polymer that are more uniform. Elliptical shapes are useful in spreading light in a slightly wider angle

The polymeric fibers themselves may also have a shape that is circular, rectilinear, elliptical, triangular, trilobal, or trapezoidal. The individual fiber shape is useful in allowing many fibers to be fused together in which the interstices can be filled more uniformly and therefore provide an optical element that is more uniform and is less likely to scatter light. In other embodiment useful in this invention the shape of the multi-component fiber and the internal fibrils may have any combination. In particular, a flat ribbon multi-component fibers that also has flat ribbon-like fibrils help to optimize the ability to provide uniformly fused fibers as well as fiber that provide uniform light reflection and transmission.

In the process for making the polymeric fibers that are useful in this invention, the relative interfacial tension and wetting of the polymers as well as the viscoelastic properties for the continuous phase and the discontinuous phases plays a role in the actual shape of the fiber. While the mechanical aspects of the orifice plates can be design to form the molten polymers to a desired shape, the relative interfacial tension and or viscosities of the polymers interacts with the process and will ultimately influence the final shape. Polymers in which the interfacial tensions and or viscosities are closely matched will take on the shape from the orifice plates better than those polymers in which the interfacial tensions are widely separated. Highly mismatched polymers will form shapes that lose sharp edge definition and tend to be blurry. There is a continuum of shapes that may be obtained between those closely or widely separated polymers. The overall physio-mechanical behavior depends on two parameters. A proper interfacial tension that provides a phase size small enough to be considered as macroscopically homogeneous and an interphase adhesion strong enough to assimilate stress and strains without changing the morphology of either phase. In useful embodiments in this invention the interfacial tension difference between the continuous phase and the discontinuous phase is less than 5 dynes/cm. It other useful embodiments of this invention the interfacial tension difference between the continuous phase and the discontinuous phase is less than 10 dynes/cm. It other useful embodiments of this invention the interfacial tension difference between the continuous phase and the discontinuous phase is less than 30 dynes/cm. It should be noted that polymeric surfactants also referred to as compatibilizers may be added to either one or both polymer. Typical materials may include blocked or grafted copolymers where segments of the copolymer matches that of either or both the discontinuous and or continuous phases in the polymeric fiber.

The copolymers may be added in a weight ratio of 0.05 to 10.percent. This range may vary depending on the degree of substitution on the copolymer.

In the formation of the optical element useful to provide reflective polarization, the fibrils are aligned to be substantially parallel in relation to each other. In some embodiments the fibrils are parallel to each between 0 to 45 degrees. Zero degrees refers to the fact that they are parallel. As the angle of the between fibrils increases, the efficient of the film will decrease. In a preferred embodiment the fibrils are between 0 to 15 degrees and in the most preferred embodiment the fibrils are parallel form 0 to 5 degrees. Useful cross-sectional shape of the polymeric fiber is circular, rectilinear, elliptical, triangular, trilobal, or trapezoidal. In should be noted that the shape of the fibers during the manufacturing process for the fibers may be altered after the processing to form a continuous solid film wherein the interstices between fibers are filled with polymeric material. Since the continuous phase in heated to the point of causing it to flow in order to get the fibers to join together and further to fill the interstices, the shape of the outer continuous phase will disappear or blend together with other fibers that form the solid continuous film.

In the manufacturing process for the polymeric fibers, the fibers may be extruded as a single mono-filaments fiber or ribbon (has one or more integrally formed multi-component fibers with fibrils) or it may be formed into a number of much smaller individual polymeric fibers with each one that has internal fibrils. If multiple fibers are formed, they are commonly pulled together into a bundle of fibers often referred to as yarn. The yarn may be treated with other materials such as a sizing material to joint the small the fiber together and to minimize fraying. This is a useful means to control individual fibers and better assure that they are parallel with the other fibers in the fiber bundle. The sizing material preferable is a material that has a refractive index that is the same or very similar to that of the continuous phase material. Materials that do not impart birefringence will help to optimize the optical performance of the polymeric fibers. The sizing material may also be removed after the fibers have been woven into a fabric. This may be accomplished by place the fabric into a bath of material that will dissolve or loosen the sizing material such that it can be flushed or rinsed from the polymeric fibers. This is useful to help assure that no other materials are impacting the performance of the polymeric fibers. If the sizing material is of sufficiently close refractive index (typically between 0.005 to 0.01), the material selected may also contain properties that enhance the adhesion as well as the filling of the interstices between the fibers. In a different process the polymeric fibers may be heated or chemically treated to fuse the individual fibers together into a larger bundle prior to be wound or woven together. This technique is preferred because no other material is introduced and therefore will not have a negative impact on the optical performance of the fibers. This technique is also useful in helping to assure that all fibers are substantially parallel to each other.

The process further provides a means of arranging the fibers in which they are substantially parallel to each other. The fibrils that are internal and an integral part of the polymeric fiber have a somewhat predetermined degree of parallelism because they are extruded out of a fixed orifice plate. In the process of winding the polymeric fibers there is a high degree of alignment that can be obtained in the winding direction. Such a process may provide a means of guiding and tensioning the fiber or yarn to provide the desired packing density. This is desirable because as the fibers are fused together, they will provide a uniform optical effect. In the process of weaving, the fiber can be aligned very well in one plane but as the polymeric fiber is interlaced with a crossing isotropic fiber both the fiber and fibrils will change direction in the height axis. The fibrils within the polymeric fiber will maintain there degree of parallelism in the length and width dimension but adjacent fibers may have a difference in their thickness plane. In the embodiments of this invention the fibrils are substantially parallel to each other. The relative degree of the parallelism may influence the optical performance of the diffusely reflecting polarizer. In one embodiment the fibrils are parallel to within 0 to 45 degrees of each other. In this description 0 degrees is consider parallel in either their length or width perspective (both are indicated because the polarizing fibers may be aligned in either the vertical or horizontal direction. While tension may be use to align the polymeric fiber to a substantially parallel, once the tension is released the fiber may tend to develop a slight curvature. One means to control this is to embed and dry (cross-link) or otherwise the fiber in an isotropic matrix while under tension. Care needs to be taken while tensioning the woven fabric so as to minimize the neck-in on any unconstrained edges. Tension may be in both the length and width tension. In other embodiments the optical element has the fibrils aligned to within 0 to 15 degrees. With more fibrils aligned in a more parallel manner, the relative amount of transmission and or reflection will be enhanced resulting in a more efficient diffusely reflecting polarizer. In the preferred embodiment of this invention the optical element comprising fibrils that are parallel to within 0 to 5 degrees of each other. Such a film is highly efficient and provides excellent light recycling of at least one polarization state so as to provide a much brighter light to the liquid crystals.

The process used to make said diffusely reflecting polarizer has an ER ratio of greater than 3 to 1, an FOM of >1.20. In order to make films with the desired balance in which said discontinuous phase material and continuous phase material taken together along at least one axis for at least one polarization state of electromagnetic radiation reflectance is at least about 50% and the diffuse transmittance of said discontinuous phase material and continuous phase material taken together along at least one axis for at least one polarization state of electromagnetic radiation is at least about 50%, the use of “island-in-the sea fibers” is needed.

In the forming of a diffusely reflecting polarizer useful in this invention, there is at least one layer of providing polymeric fibers that comprise discontinuous phase birefringent fibrils substantially parallel to each other and dispersed in a polymeric continuous phase. The number of layers within the polarizing film is dependant on the polymeric fiber, the number of optical interfaces, their distribution, the of shape of fibrils, the optical thickness of the fibrils and the spacing between the fibrils as well as the relative refractive index difference between the continuous phase and the non-continuous phase. In some embodiments having more than one layer is useful in assuring that there is sufficient number of fibers and fibrils to assure complete coverage across the wound or woven diffusely reflecting polarizer. In winding or weaving there may be spaces between fibers that effectively creates a “void or hole” in the polarization effect. This may not be a physical hole but an area that is devoid of or has a reduced number of fibrils and therefore causes a change in the polarization effect. An example would be to have a polymer skin layer without fibrils that is used to adhere or join two polarizing layers comprising fibrils, joining a layer with polarizing fibrils with a layer of polarizing immiscible polymer, joining a layer with polarizing fibrils with a stacked layer polarizing film or some combination thereof ( a fibril film that also contains immiscible polymer regions . . . etc). By providing addition layer or optical interfaces formed by the fibrils both the transmission and reflection properties can better be optimized to provide the highest amount of polarization recycling.

In other embodiments in which there is a first and at least a second or more layer, the first layer may have a different type of polymeric fiber than the second layer. This may include but is not limited to the physical geometry of the fiber, the size, shape, distribution and material of the continuous and or the discontinuous phase. Mixing and matching these parameters is useful in providing the optimal polarization effect as well as overall light control for shaping, collimation, spread and or spectrum control. Additionally features may be formed into the melt fused sheet made from the polymeric fibers of this invention or added to at least one surface. The features may be continuous or discrete elements. They may be patterned or random. The features may include lenlets, circular, rectilinear, elliptical, triangular, trilobal, or trapezoidal or pyramidal. Such features may be elongated in one or more directions.

The diffusely reflecting polarizer may be adhered to one or more layers to provide physical and or optical properties. This may include a slab diffuser, a back diffuser, a light enhancement film, a liquid crystal containing layer, a color filter, and or stiffening sheet or member. These sheets, layers and member may have a thickness range of between 1 and 800 microns (individually or in combination with each other.

### Further Definitions

As used herein, the term “extinction ratio” is defined to mean the ratio of total light transmitted in one polarization to the light transmitted in an orthogonal polarization.

The indices of refraction of the continuous and discontinuous phases are substantially matched (i.e., differ by less than about 0.05) along a first of three mutually orthogonal axes, and are substantially mismatched (i.e., differ by more than about 0.05) along a second of three mutually orthogonal axes. Preferably, the indices of refraction of the continuous and discontinuous phases differ by less than about 0.03 in the match direction, more preferably, less than about 0.02, and most preferably, less than about 0.01. The indices of refraction of the continuous and discontinuous phases preferably differ in the mismatch direction by at least about 0.07, more preferably, by at least about 0.1, and most preferably, by at least about 0.2.

The mismatch in refractive indices along a particular axis has the effect that incident light polarized along that axis will be substantially scattered, resulting in a significant amount of reflection. By contrast, incident light polarized along an axis in which the refractive indices are matched will be spectrally transmitted or reflected with a much lesser degree of scattering. This effect can be utilized to make a variety of optical devices, including reflective polarizers and mirrors.

### Effect of Index Match/Mismatch

The magnitude of the index match or mismatch along a particular axis directly affects the degree of scattering of light polarized along that axis. In general, scattering power varies as the square of the index mismatch. Thus, the larger the index mismatch along a particular axis, the stronger the scattering of light polarized along that axis. Conversely, when the mismatch along a particular axis is small, light polarized along that axis is scattered to a lesser extent and is thereby transmitted specularly through the volume of the body.

### Skin Layers

A layer of material which is substantially free of a discontinuous phase may be disposed on one or both major surfaces of the film, i.e., the extruded composite the discontinuous phase and the continuous phase. The composition of the layer, also called a skin layer, may be chosen, for example, to protect the integrity of the discontinuous phase within the extruded blend, to add mechanical or physical properties to the final film or to add optical functionality to the final film. Suitable materials of choice may include the material of the continuous phase or the material of the discontinuous phase.

A skin layer or layers may also add physical strength to the resulting composite or reduce problems during processing, such as, for example, reducing the tendency for the film to split during the orientation process. Skin layer materials which remain amorphous may tend to make films with a higher toughness, while skin layer materials which are semicrystalline may tend to make films with a higher tensile modulus. Other functional components such as antistatic additives, UV absorbers, dyes, antioxidants, and pigments, may be added to the skin layer, provided they do not substantially interfere with the desired optical properties of the resulting product.

The skin layers may be applied to one or two sides of the extruded blend at some point during the extrusion process, i.e., before the extruded blend and skin layer(s) exit the extrusion die. This may be accomplished using conventional coextrusion technology, which may include using a three-layer coextrusion die. Lamination of skin layer(s) to a previously formed film of an extruded blend is also possible. Total skin layer thicknesses may range from about 2% to about 50% of the total blend/skin layer thickness.

A wide range of polymers are suitable for skin layers. Predominantly amorphous polymers include copolyesters based on one or more of terephthalic acid, 2,6-naphthalene dicarboxylic acid, isophthalic acid phthalic acid, or their alkyl ester counterparts, and alkylene diols, such as ethylene glycol. Examples of semicrystalline polymers are 2,6-polyethylene naphthalate, polyethylene terephthalate, and nylon materials.

### Antireflection Layers

The films and other optical devices made in accordance with the invention may also include one or more anti-reflective layers. Such layers, which may or may not be polarization sensitive, serve to increase transmission and to reduce reflective glare. An anti-reflective layer may be imparted to the films and optical devices of the present invention through appropriate surface treatment, such as coating or sputter etching.

In some embodiments of the present invention, it is desired to maximize the transmission and/or minimize the specular reflection for certain polarizations of light. In these embodiments, the optical body may comprise two or more layers in which at least one layer comprises an anti-reflection system in close contact with a layer providing the continuous and discontinuous phases. Such an anti-reflection system acts to reduce the specular reflection of the incident light and to increase the amount of incident light that enters the portion of the body comprising the continuous and discontinuous layers. Such a function can be accomplished by a variety of means well known in the art. Examples are quarter wave anti-reflection layers, two or more layer anti-reflective stack, graded index layers, and graded density layers. Such antireflection functions can also be used on the transmitted light side of the body to increase transmitted light if desired. It may also be desirable to provide additional functionality with or separately from the anti-reflection layer such as hard coats to minimize scratching if the adjacent film and their surface moves in relation to the other film surface. This may occur during manufacturing or assembling the film or in normal usage due to differential expansion or contraction. Such material may include UV crosslinkable monomeras well as chemical crosslinked materials. Such material may also contain other addenda to control or modify the frictional properties of the layer.

### More Than Two Phases

The optical elements made in accordance with the present invention may also consist of more than two phases. Thus, for example, an optical material made in accordance with the present invention can consist of two different discontinuous phases within the continuous phase. The second discontinuous phase could be randomly or non-randomly dispersed throughout the fibrils, and can be aligned along a common axis.

Optical elements made in accordance with the present invention may also consist of more than one continuous phase. Thus, in some embodiments, the optical body may include, in addition to a first continuous phase and a discontinuous phase, a second phase which is co-continuous in at least one dimension with the first continuous phase. In one particular embodiment, the second continuous phase is a porous, sponge-like material that is coextensive with the first continuous phase (i.e., the first continuous phase extends through a network of channels or spaces extending through the second continuous phase, much as water extends through a network of channels in a wet sponge). In a related embodiment, the second continuous phase is in the form of a dendritic structure which is coextensive in at least one dimension with the first continuous phase.

### Multilayer Combinations

If desired, one or more sheets of a continuous/disperse phase film made in accordance with the present invention may be used in combination with, or as a component in, a multilayered film (i.e., to increase reflectivity). Suitable multilayered films include those of the type described in WO 95/17303 (Ouderkirk et al.). In such a construction, the individual sheets may be laminated or otherwise adhered together or may be spaced apart with the polymeric sheet of this invention. If the optical thicknesses of the phases within the sheets are substantially equal (that is, if the two sheets present a substantially equal and large number of scatterers to incident light along a given axis), the composite will reflect, at somewhat greater efficiency, substantially the same band width and spectral range of reflectivity (i.e., “band”) as the individual sheets. If the optical thicknesses of phases within the sheets are not substantially equal, the composite will reflect across a broader band width than the individual phases. A composite combining mirror sheets with polarizer sheets is usefuil for increasing total reflectance while still polarizing transmitted light.

### Additives

The optical materials of the present invention may also comprise other materials or additives as are known to the art. Such materials include pigments, dyes, binders, coatings, fillers, compatibilizers, antioxidants (including sterically hindered phenols), surfactants, antimicrobial agents, antistatic agents, flame retardants, foaming agents, lubricants, reinforcers, light stabilizers (including UV stabilizers or blockers), heat stabilizers, impact modifiers, plasticizers, viscosity modifiers, and other such materials. Furthermore, the films and other optical devices made in accordance with the present invention may include one or more outer layers which serve to protect the device from abrasion, impact, or other damage, or which enhance the processability or durability of the device.

Suitable lubricants for use in the present invention include calcium sterate, zinc sterate, copper sterate, cobalt sterate, molybdenum neodocanoate, and ruthenium (III) acetylacetonate.

Antioxidants useful in the present invention include 4,4′-thiobis-(6-t-butyl-m-cresol), 2,2′-methylenebis-(4-methyl-6-t-butyl-butylphenol), octadecyl-3,5-di-t-butyl-4-hydroxyhydrocinnamate, bis-(2,4-di-t-butylpheny)pentaerythritol diphosphite, Irganox™ 1093 (1979)(((3,5-bis(1,1-dimethylethyl)-4-hydroxyphenyl)methyl)-dioctadecyl ester phosphonic acid), Irganox™ 1098 (N,N′-1,6-hexanediylbis(3, 5-bis(1,1-dimethyl)-4-hydroxy-benzenepropanamide), Naugaard™ 445 (aryl amine), Irganox™ L 57 (alkylated diphenylamine), Irganox™ L 115 (sulfur containing bisphenol), Irganox™ LO 6 (alkylated phenyl-delta-napthylamine), Ethanox 398 (flourophosphonite), and 2,2′-ethylidenebis(4,6-di-t-butylphenyl)fluorophosnite.

A group of antioxidants that are especially preferred are sterically hindered phenols, including butylated hydroxytoluene (BHT), Vitamin E (di-alphatocopherol), Irganox™ 1425WL(calcium bis-(O-ethyl(3,5-di-t-butyl-4-hydroxybenzyl))phosphonate), Irganox™ 1010 (tetrakis(methylene(3,5,di-t-butyl-4-hydroxyhydrocinnamate))methane), Irganox™ 1076 (octadecyl 3,5-di-tert-butyl-4-hydroxyhydrocinnamate), Ethanox™ 702 (hindered bis phenolic), Etanox 330 (high molecular weight hindered phenolic), and Ethanox™ 703 (hindered phenolic amine).

Dichroic dyes are a particularly useful additive in some applications to which the optical materials of the present invention may be directed, due to their ability to absorb light of a particular polarization when they are molecularly aligned within the material. When used in a film or other material which predominantly scatters only one polarization of light, the dichroic dye causes the material to absorb one polarization of light more than another. Suitable dichroic dyes for use in the present invention include Congo Red (sodium diphenyl-bis-oc-naphthylamine sulfonate), methylene blue, stilbene dye (Color Index (CI)=620), and 1,1′-diethyl-2,2′-cyanine chloride (CI=374 (orange) or CI=518 (blue)). The properties of these dyes, and methods of making them, are described in E. H. Land, Colloid Chemistry (1946). These dyes have noticeable dichroism in polyvinyl alcohol and a lesser dichroism in cellulose. A slight dichroism is observed with Congo Red in PEN.

Other suitable dyes include the following materials: [CHEM-1] The properties of these dyes, and methods of making them, are discussed in the Kirk Othmer Encyclopedia of Chemical Technology, Vol. 8, pp. 652-661 (4th Ed. 1993), and in the references cited therein.

When a dichroic dye is used in the optical bodies of the present invention, it may be incorporated into either the continuous or discontinuous phase. However, it is preferred that the dichroic dye is incorporated into the discontinuous phase.

Dychroic dyes in combination with certain polymer systems exhibit the ability to polarize light to varying degrees. Polyvinyl alcohol and certain dichroic dyes may be used to make films with the ability to polarize light. Other polymers, such as polyethylene terephthalate or polyamides, such as nylon-6, do not exhibit as strong an s ability to polarize light when combined with a dichroic dye. The polyvinyl alcohol and dichroic dye combination is said to have a higher dichroism ratio than, for example, the same dye in other film forming polymer systems. A higher dichroism ratio indicates a higher ability to polarize light.

Molecular alignment of a dichroic dye within an optical body made in accordance with the present invention is preferably accomplished by stretching the optical body after the dye has been incorporated into it. However, other methods may also be used to achieve molecular alignment. Thus, in one method, the dichroic dye is crystallized, as through sublimation or by crystallization from solution, into a series of elongated notches that are cut, etched, or otherwise formed in the surface of a film or other optical body, either before or after the optical body has been oriented. The treated surface may then be coated with one or more surface layers, may be incorporated into a polymer matrix or used in a multilayer structure, or may be utilized as a component of another optical body. The notches may be created in accordance with a predetermined pattern or diagram, and with a predetermined amount of spacing between the notches, so as to achieve desirable optical properties.

In a related embodiment, the dichroic dye may be disposed within one or more hollow fibers or other conduits, either before or after the hollow fibers or conduits are disposed within the optical body. The hollow fibers or conduits may be constructed out of a material that is the same or different from the surrounding material of the optical body.

In yet another embodiment, the dichroic dye is disposed along the layer interface of a multilayer construction, as by sublimation onto the surface of a layer before it is incorporated into the multilayer construction. In still other embodiments, the dichroic dye is used to at least partially backfill the voids in a microvoided film made in accordance with the present invention.

### Functional layers

Various functional layers or coatings may be added to the optical films and devices of the present invention to alter or improve their physical or chemical properties, particularly along the surface of the film or device. Such layers or coatings may include, for example, slip agents, low adhesion backside materials, conductive layers, antistatic coatings or films, barrier layers, flame retardants, UV stabilizers, abrasion resistant materials, optical coatings, or substrates designed to improve the mechanical integrity or strength of the film or device.

The films and optical devices of the present invention may be given good slip properties by treating them with low friction coatings or slip agents, such as polymer beads coated onto the surface. Alternately, the morphology of the surfaces of these materials may be modified, as through manipulation of extrusion conditions, to impart a slippery surface to the film; methods by which surface morphology may be so modified are described in U.S. Ser. No. 08/612,710.

In some applications, as where the optical films of the present invention are to be used as a component in adhesive tapes, it may be desirable to treat the films with low adhesion backsize (LAB) coatings or films such as those based on urethane, silicone or fluorocarbon chemistry. Films treated in this manner will exhibit proper release properties towards pressure sensitive adhesives (PSAs), thereby enabling them to be treated with adhesive and wound into rolls. Adhesive tapes made in this manner can be used for decorative purposes or in any application where a diffusely reflective or transmissive surface on the tape is desirable.

The films and optical devices of the present invention may also be provided with one or more conductive layers. Such conductive layers may comprise metals such as silver, gold, copper, aluminum, chromium, nickel, tin, and titanium, metal alloys such as silver alloys, stainless steel, and intone, and semiconductor metal oxides such as doped and undoped tin oxides, zinc oxide, and indium tin oxide (ITO).

The films and optical devices of the present invention may also be provided with antistatic coatings or films. Such coatings or films include, for example, V₂O₅ and salts of sulfonic acid polymers, carbon or other conductive metal layers.

The optical films and devices of the present invention may also be provided with one or more barrier films or coatings that alter the transmissive properties of the optical film towards certain liquids or gases. Thus, for example, the devices and films of the present invention may be provided with films or coatings that inhibit the transmission of water vapor, organic solvents, O 2, or CO 2 through the film. Barrier coatings will be particularly desirable in high humidity environments, where components of the film or device would be subject to distortion due to moisture permeation.

The optical films and devices of the present invention may also be treated with flame retardants, particularly when used in environments, such as on airplanes, that are subject to strict fire codes. Suitable flame retardants include aluminum trihydrate, antimony trioxide, antimony pentoxide, and flame retarding organophosphate compounds.

The optical films and devices of the present invention may also be provided with abrasion-resistant or hard coatings, which will frequently be applied as a skin layer. These include acrylic hardcoats such as Acryloid A-11 and Paraloid K-120N, available from Rohm & Haas, Philadelphia, Pa.; urethane acrylates, such as those described in U.S. Pat. No. 4,249,011 and those available from Sartomer Corp., Westchester, Pa.; and urethane hardcoats obtained from the reaction of an aliphatic polyisocyanate (e.g., Desmodur N-3300, available from Miles, Inc., Pittsburgh, Pa.) with a polyester (e.g., Tone Polyol 0305, available from Union Carbide, Houston, Tex.).

The optical films and devices of the present invention may further be laminated to rigid or semi-rigid substrates, such as, for example, glass, metal, acrylic, polyester, and other polymer backings to provide structural rigidity, weatherability, or easier handling. For example, the optical films of the present invention may be laminated to a thin acrylic or metal backing so that it can be stamped or otherwise formed and maintained in a desired shape. For some applications, such as when the optical film is applied to other breakable backings, an additional layer comprising PET film or puncture-tear resistant film may be used.

The optical films and devices of the present invention may also be provided with shatter resistant films and coatings. Films and coatings suitable for this purpose are described, for example, in publications EP 592284 and EP 591055, and are available commercially from 3M Company, St Paul, Minn.

Various optical layers, materials, and devices may also be applied to, or used in conjunction with, the films and devices of the present invention for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors.

Multiple additional layers on one or both major surfaces of the optical film are contemplated, and can be any combination of aforementioned coatings or films. For example, when an adhesive is applied to the optical film, the adhesive may contain a white pigment such as titanium dioxide to increase the overall reflectivity, or it may be optically transparent to allow the reflectivity of the substrate to add to the reflectivity of the optical film.

In order to improve roll formation and convertibility of the film, the optical films of the present invention may also comprise a slip agent that is incorporated into the film or added as a separate coating. In most applications, slip agents will be added to only one side of the film, ideally the side facing the rigid substrate in order to minimize haze.

### Region of Spectrum

While the present invention is frequently described herein with reference to the visible region of the spectrum, various embodiments of the present invention can be used to operate at different wavelengths (and thus frequencies) of electromagnetic radiation through appropriate scaling of the components of the optical body. Thus, as the wavelength increases, the linear size of the components of the optical body may be increased so that the dimensions of these components, measured in units of wavelength, remain approximately constant.

Of course, one major effect of changing wavelength is that, for most materials of interest, the index of refraction and the absorption coefficient change. However, the principles of index match and mismatch still apply at each wavelength of interest, and may be utilized in the selection of materials for an optical device that will operate over a specific region of the spectrum. Thus, for example, proper scaling of dimensions will allow operation in the infrared, near-ultraviolet, and ultra-violet regions of the spectrum. In these cases, the indices of refraction refer to the values at these wavelengths of operation, and the body thickness and size of the discontinuous phase scattering components may also be approximately scaled with wavelength. Even more of the electromagnetic spectrum can be used, including very high, ultrahigh, microwave and millimeter wave frequencies. Polarizing and diffusing effects will be present with proper scaling to wavelength and the indices of refraction can be obtained from the square root of the dielectric function (including real and imaginary parts). Useful products in these longer wavelength bands can be diffuse reflective polarizers and partial polarizers.

In some embodiments of the present invention, the optical properties of the optical body vary across the wavelength band of interest. In these embodiments, materials may be utilized for the continuous and/or discontinuous phases whose indices of refraction, along one or more axes, varies from one wavelength region to another.

### Thickness of Optical Body

The thickness of the optical body is also an important parameter which can be manipulated to affect reflection and transmission properties in the present invention. As the thickness of the optical body increases, diffuse reflection also increases, and transmission, both specular and diffuse, decreases. Thus, while the thickness of the optical body will typically be chosen to achieve a desired degree of mechanical strength in the finished product, it can also be used to directly to control reflection and transmission properties.

Thickness can also be utilized to make final adjustments in reflection and transmission properties of the optical body. Thus, for example, in film applications, the device used to extrude the film can be controlled by a downstream optical device which measures transmission and reflection values in the extruded film, and which varies the thickness of the film (i.e., by adjusting extrusion rates or changing casting wheel speeds) so as to maintain the reflection and transmission values within a predetermined range.

### Geometry of Discontinuous Phase

While the index mismatch is the predominant factor relied upon to promote scattering in the films of the present invention (i.e., a diffuse mirror or polarizer made in accordance with the present invention has a substantial mismatch in the indices of refraction of the continuous and discontinuous phases along at least one axis), the geometry of the discontinuous phase can have a secondary effect on scattering. Thus, the depolarization factors of the particles for the electric field in the index of refraction match and mismatch directions can reduce or enhance the amount of scattering in a given direction. For example, when the discontinuous phase is elliptical in a cross-section taken along a plane perpendicular to the axis of orientation, the elliptical cross-sectional shape of the discontinuous phase contributes to the asymmetric diffusion in both back scattered light and forward scattered light. The effect can either add or detract from the amount of scattering from the index mismatch, but generally has a small influence on scattering in the preferred range of properties in the present invention.

The shape of the discontinuous phase can also influence the degree of diffusion of light scattered from the particles. This shape effect is generally small but increases as the aspect ratio of the geometrical cross-section of the particle in the plane perpendicular to the direction of incidence of the light increases and as the particles get relatively larger. In general, in the operation of this invention, the discontinuous phase should be sized less than several wavelengths of light in one or two mutually orthogonal dimensions if diffuse, rather than specular, reflection is preferred.

Preferably, for a low loss reflective polarizer, the preferred embodiment consists of a discontinuous phase disposed within the continuous phase as a series of rod-like structures which, as a consequence of orientation, have a high aspect ratio which can enhance reflection for polarizations parallel to the orientation direction by increasing the scattering strength and dispersion for that polarization relative to polarizations perpendicular to the orientation direction.

The invention has been described in detail with particular reference to certain preferred embodiments thereof, but it will be understood that variations and modifications can be effected within the spirit and scope of the invention. The entire contents of the patents and other publications referred to in this specification are incorporated herein by reference.

### EXAMPLE 1

A diffusely reflecting polarizer was made by extruding bi-component fibers with PEN fibrils in a sea polymer of PET-G. The fibers were made using a series of orifice/flow plates. The orifice/flow plates produced 72 filaments of bi-component polymer each approximately 40 microns in diameter with 1410 internal fibrils within each filament. The relative cross sectional diameter of the fibrils was between 90 to 1000 nm with substantially uniform distribution within the fiber diameter. The fibrils were substantially cylinder to slightly oval shaped in their cross-direction. The fibrils were surrounded by the sea polymer which was a copolymer of polyester. Both the PEN and the copolyester were dried for at least 8 hours in a hot air vacuum dryer to remove any residual moisture. Each polymer was feed into their own individual extruder and gear pump to melt and pump the polymer. The molten flows were feed into the orifice plates that provided a means to divide the single streams of polymers into multiple smaller flows. The orifice and flow plates allowed the polymers to be split and their combined in a manner that the fibrils (PEN) is encapsulated or surrounded by the sea polymer (copolyester). The resulting polymer is extruded out of the spinnerette pack as 72 individual filaments each comprising 1410 fibrils. The filaments are allowed to freefall in air several feet (air cooled) where they are pulled together in a lose bundle. The bundle of filaments (yarn) is then cold drawn approximately 3.5 to 1 in the length direction by a series of differential sped temperature control rollers. The yarn is then wound on a bobbin. The cold draw was done at a temperature of approximately 120-130 C. In a second operation the yarn was wound around a glass block with a smooth surface approximately ½″ thick. A sheet of Kapton film was placed between the glass block and fibers to provide improved release of the fibers after they have been melt fused together. The fibers were positioned to assure that they were essentially parallel to each other and the fibers were touching each other. A second sheet of Kapton film was placed on each of the wound fibers surface (top and bottom) and a polished metal plate was placed on each surface. The assemble was then placed in a temperature control press at 190 F for 3 minutes with 1000 pounds of pressure. Without changing pressure, the sample was cooled to 72 F (approx. 10 minutes). The sample was removed from the press and peeled off the block/Kapton surface. The resulting sample was fused into a highly transparent film. The sample was 6 mil thick. The sample was then tested on a light table by transmitting light through the sample and positional changing an absorptive polarizer (90 degree rotation) in relation to the sample. The sample demonstrated a high degree of polarization. The sample was measured on the Eldim Model160R to evaluate their angular luminance profile and gain over a conventional absorptive polarizer. The sample was also evaluated on a Perkin Elmer Lamda 650 to evaluate the relative amount of polarized light transmission and reflection. A Figure of Merit was calculated as described above.

### EXAMPLE 2

In another example fiber were made in a similar manner as the fibers described in example 1 expect the orifice plates used produced an internal fibril count of 720.

### EXAMPLE 3

This example was the same as example #1 except the sea polymer was a co-polyester

### EXAMPLE 4

This sample was prepared the same as example 3 except a clear transparent film of PET G was fused to both sides of the fiber based film. This was achieved by initial casting the PET-G resin into a crystal clear film and then melt fusing it to the surface of the film formed by the bicomponent fibers. The final film thickness was 11 mils.

### EXAMPLE 5

This sample was prepared in the same manner as example #1 except two samples of polarizing film were made by the melt fusing process and then the two films were fused to each other.

### Materials Used in the Above Examples

PEN used is VFR-40102 from M&G Group (extrusion temperature—300 C)

PETG used is Eastar 6763 from Eastman Chemical company (extrusion temperature—280 C)

COPET used is Crystar—Merge 3991 from DuPont Company(extrusion temperature—240 C)

TABLE # 1

| | | | Visual | Eldim | | | |
|---|---|---|---|---|---|---|---|
| | # of | | polarization | Max % | T Max % | R Max % | |
| Example # | Fibril | Material | Assessment | Gain | Transmission | Reflectance | FOM |
| 1 | 1410 | PEN | Strong | 20% | 86.2 | 75.8 | 155 |
| | | Fibril/Co- | | | | | |
| | | PET Sea | | | | | |
| 2 | 720 | PEN | Moderate | 15% | 81 | 62 | 130 |
| | | Fibril/Co- | | | | | |
| | | PET Sea | | | | | |
| 3 | 1410 | Pen | Moderate/ | 17% | 77.0 | 71.1 | 138 |
| | | Fibril/Co | strong | | | | |
| | | PET sea | | | | | |
| | | polymer | | | | | |
| 4 | 1410 | Pen | Strong | 19% | 83.7 | 71 | 146 |
| | | Fibril/PE | | | | | |
| | | T-G sea | | | | | |
| | | polymer | | | | | |
| 5 | 1410 | Pen | Strong | 20.4 | 86 | 74 | 151 |
| | | Fibril/Co | | | | | |
| | | PET sea | | | | | |
| | | polymer. | | | | | |
| | | 2 layers | | | | | |

The visual assessment for polarization is a qualitative determination made by viewing the sample in transmitted light and then rotating an absorptive polarizer 90 degrees and assessing the relative amount of transmission versus the relative amount of light block. The samples were rated as none, weak. moderate or strong with no difference in viewing for none and progressively more and more change in viewing for weak to strong.

Max. % Gain: Samples were measured with a Aquos Direct backlight with a standard slab diffuser. Light was transmitted through the sample and luminance values collected from +80 to −80 degrees using the Eldim Model 160R. The gain values were determined by a simple ratio of the measured example values divided by the value from an absorptive polarizer.

The data from table 1 above demonstrates that a high efficiency reflective polarizer can be made from bi-component fibers that have internal fibrils. Samples 1-5 all demonstrated the ability to polarizer light. They all had positive gain values over conventional absorptive polarizers with efficiency from 15 to 20+ %. All sample had transmissions of one polarization phase of light from 77-86.2% while reflecting the other polarizing phase from 62-75.8%. Sample #2 had the lowest number of fibrils within a given filament and also had the lowest FOM number. The 2-layer sample (example 5) had an FOM of 151 while example 3 had an FOM of 138 and example #2 that had an FOM of 130. Additional sample 5 (74%) had a higher reflection than samples #3 (71.1%) and 2 (62%). This indicates that the number of fibrils in the thickness dimension provides additional benefit for the reflection of polarized light. The data on these sample also shows and improvement in the transmission properties of the sample with more layers.

### PARTS LIST

10 is an island in the sea fiber
13 is a fibril (discontinuous phase)
15 sea polymer (continuous phase polymer) of an island in the sea fiber
17 is a symbol showing the ordinary and extraordinary refractive index of the sea polymer
19 is a symbol showing the ordinary and extraordinary refractive index of the fibril
20 is an elliptical shaped island in the sea fiber
21 is an elliptical shaped fibril
23 is a radical(circular) shaped fibril
25 is a flat fibril
27 is a random plate-like fibril
29 is a triangular shaped fibril
30 is a ribbon shaped island in the sea polymer
31 is a star shaped fibril
33 is a stack plate-like fibrils
35 is an integral lens shape
40 ribbon like island in the sea fiber with lens
60 is a woven polarizer
61 island in the sea fibers
63 is an isotropic fiber
65 is a polymer matrix
70 is a end view of a fiberous polarizer
71 is several island in the sea fiber that have been melt fused and embedded in a polymer
80 is optical film
81 is a cross weft fiber
83 polymeric polarizing fibers
91 is a bundle of island in the sea fibers
93 is internal fibrils
95 is sizing material
100 is a top view of a diffuse reflecting polarizing sheet
101 is the width dimension of the diffuse reflecting polarizing sheet
103 in internal fibrils
105 is the length dimension of the diffuse reflecting polarizing sheet
110 is an end view of a woven diffuse reflecting polarizing sheet
111 is a polymeric fiber
113 is the sea polymer
120 side view of the length dimension of a woven diffuse reflecting polarizing sheet
121 are fibrils
123 is sea polymer
125 are isotropic fibers
130 is a solid film
131 is ribbon shaped island in the sea fibers
133 is flat plate-like fibrils
135 is sea polymer that has been melted and then re-solidified

1. A process for making a diffusely reflecting polarizer comprising the steps of:
a) providing polymeric fibers that comprise discontinuous phase birefringent fibrils substantially parallel to each other and dispersed in a polymeric continuous phase wherein at least one of said continuous and or discontinuous phases are bireflingent;
b) arranging the fibers in a substantially parallel array;
c) forming the fiber array into a continuous solid film wherein the interstices between fibers are filled with polymeric material.

2. The process of claim 1 wherein said arranging the fibers in a substantially parallel array is a weaving process.

3. The process of claim 2 wherein said weaving process comprises polymeric fibers that comprise discontinuous phase bireflingent fibrils substantially parallel to each other and dispersed in a polymeric continuous phase and isotropic fibers that are not parallel to said polymeric fibers.

4. The process of claim 3 wherein the isotropic fibers comprise material for which the refractive index is substantially equal to the refractive index of the polymeric continuous phase of said polymeric fibers that comprise discontinuous phase birefringent fibrils substantially parallel to each other and dispersed in a polymeric continuous phase.

5. The process of claim 4 fibers wherein the substantially equal refractive index is one where the refractive index difference is less than 0.02.

6. The process of claim 1 wherein said polymeric fibers that comprise discontinuous phase birefringent fibrils comprises polyester.

7. The process of claim 6 wherein said polyester comprises polyethylene(terephthalate), polyethylene(naphthalate), or a copolymer thereof.

8. The process of claim 6 wherein the polyester comprises polyethylene(terephthalate) or polyethylene(naphthalate).

9. The process of claim 1 wherein said polymeric continuous phase comprises at least one material selected from the group consisting of polyester, an acrylic, or an olefin and copolymers thereof.

10. The process of claim 7 wherein said polymeric continuous phase wherein the continuous phase comprises polyethylene(terephthalate), poly(methyl-methacrylate), poly(cyclo-olefin), or and copolymers thereof.

11. The process of claim 7 wherein said polymeric continuous phase wherein the continuous phase comprises poly(1,4-cyclohexylene dimethylene terephthalate).

12. The process of claim 1 wherein said arranging the fibers in a substantially parallel array is a winding process.

13. The process claim 1 wherein said forming the fiber array into a continuous solid film wherein the interstices between fibers are filled with polymeric material is melt fusing of the continuous phase.

14. The process of claim 13 wherein said melt fusing further comprise pressure.

15. The process of claim 1 wherein said interstices between fibers are filled with polymeric material further comprising at least one sheet of polymer.

16. The process of claim 13 wherein said at least one sheet of polymer has a refractive index substantially equal to the refractive index of continuous phase of said polymeric fiber that comprise discontinuous phase birefringent fibrils substantially parallel to each other and dispersed in a polymeric continuous phase.

17. The process of claim 1 wherein said polymeric fibers that comprise discontinuous phase materials that has a melting temperature different than the melting temperature of the polymeric continuous phase.

18. The process of claim 1 wherein said number of fibrils in said polymeric fiber is greater than 50.

19. The process of claim 1 wherein said polymeric fiber have a ratio of discontinuous phase to continuous phase on a weight basis is less than 2 to 1.

20. The process of claim 1 wherein the fibers have been cold drawn at least 3 to 1.

21. The process of claim 1 wherein the cross-sectional shape of the polymeric fiber and the birefringent fibrils is selected from the group consisting of circular, rectilinear, elliptical, triangular, trilobal, and trapezoidal.

22. The process of claim 1 wherein said diffusely reflecting polarizer has an ER ratio of greater than 3 to 1.

23. The process of claim 1 wherein said diffusely reflecting polarizer has the diffuse reflectivity of said discontinuous phase material and continuous phase material taken together along at least one axis for at least one polarization state of electromagnetic radiation is at least about 50%, the diffuse transmittance of said discontinuous phase material and continuous phase material taken together along at least one axis for at least one polarization state of electromagnetic radiation is at least about 50%.

24. An optical element comprising a film containing a layer including continuous phase and discontinuous phase materials, wherein the discontinuous phase materials are fibrils and include a material having a different refractive index in the orthogonal X and Y directions in a plane perpendicular to the direction of light travel.

25. The optical element comprising a film of claim 24 wherein said film has the diffuse reflectivity of said discontinuous phase material and continuous phase material taken together along at least one axis for at least one polarization state of electromagnetic radiation is at least about 50%, the diff-use transmittance of said discontinuous phase material and continuous phase material taken together along at least one axis for at least one polarization state of electromagnetic radiation is at least about 50%.

26. The optical element comprising a film of claim 24 wherein said film has a figure of merit of at least 1.2.

27. The optical element comprising a film of claim 24 in an LCD display.

28. The optical element comprising a film of claim 24 wherein said polymeric continuous phase and discontinuous phase independently comprise at least one material selected from the group consisting of polyester, an acrylic, or an olefin and copolymers thereof.

29. The optical element comprising a film of claim 24 wherein said polymeric continuous phase and discontinuous phases comprise polyethylene(terephthalate), poly(methyl-methacrylate), poly(cyclo-olefin), or and copolymers thereof.

30. The optical element comprising a film of claim 24 wherein said polymeric continuous phase wherein the continuous phase comprises poly(1,4-cyclohexylene dimethylene terephthalate).

31. The optical element comprising a film of claim 24 wherein said number of fibrils in said polymeric fiber is greater than 100.

32. The optical element comprising a film of claim 24 wherein said fibrils each have a cross sectional area of less than 3 square microns.

33. The optical element comprising a film of claim 24 wherein a ratio of discontinuous phase to continuous phase on a weight basis is less than 2 to 1.

34. The optical element comprising a film of claim 24 wherein said comprising said fibrils are parallel to within 0 to 5 degrees of each other.

35. The optical element comprising a film of claim 24 wherein the birefringent fibril discontinuous polymeric phase has a cross-sectional shape that is circular, rectilinear, elliptical, triangular, trilobal, or trapezoidal.

36. The optical element comprising a film of claim 24 wherein said polymeric fiber and said fibril have any combination shape of circular, rectilinear, elliptical, triangular, trilobal, or trapezoidal.

37. An optical element comprising a film containing a layer including continuous phase and discontinuous phase materials, wherein the discontinuous phase materials are discontinuous fibrils in their length dimension (domains) dispersed in an immiscible phase with the same refractive index as the continuous phase polymer and include a birefringent material having a different refractive index in the orthogonal X and Y directions in a plane perpendicular to the direction of light travel.

38. A display comprising a diffusely reflecting polarizer film comprising containing a layer including continuous phase and discontinuous phase materials, wherein the discontinuous phase materials are also discontinuous fibrils in their length dimension, dispersed in an immiscible phase polymer with the same refractive index as the continuous phase polymer and include a birefringent material having a different refractive index in the orthogonal X and Y directions in a plane perpendicular to the direction of light travel.

39. The display of claim 32 further comprises at least one function selected from the group consisting of image viewing screen, antireflection layer, ambient light suppression, color filter array, light valve, illuminantion enhancement, light columnation, light directing, light diffusion, stiffening, resistance to thermal expansion, light spreading, a light source, image algorithm, image storage, image buffer, optical brightener, IR reflection and a power source.
